(19) United States
(12) Patent Application Publication
(10) Pub. No.: US 2012/0042628 A1
(43) Pub. Date: Feb. 23, 2012

(54) Robotic manipulator

(75) Inventor: Mark E. Rosheim, Minneapolis, MN (US)

(73) Assignee: Ross-Hime Designs, Inc., Minneapolis, MN (US)

(21) Appl. No.: 12/455,336

(22) Filed: Jun. 1, 2009

Related U.S. Application Data
(60) Provisional application No. 61/130,438, filed on May 30, 2008.

(51) Int. Cl. F02K 1/00

(52) U.S. Cl. 60/232

(57) ABSTRACT

A controlled relative motion system that permits a controlled motion member, joined to a base member, to selectively move with respect to said base member having a base support, an output structure, and a plurality of securing links including a fixed length securing link that is rotatably connected at one end thereof to the base support and rotatably connected at an opposite end thereof to the output structure. Further included is a variable length securing link that is rotatably connected at one end thereof to the base support and rotatably connected at an opposite end thereof to the output structure and having a force distributor therewith that can be directed to vary a separation distance between said ends thereof by a force imparting member capable of directing the force distributor to vary the separation distance between the variable length securing link ends. The variable length securing link also has a rotatable capstan therewith about which a cable can be selectively wrapped or unwrapped through rotating this capstan by a force imparting member to vary the separation distance between the variable length securing link ends. The system can be used with a jet propulsion engine in a moveable vehicle that can also have therein a controlled signal processing relative motion system.

### CROSS-REFERENCE TO RELATED APPLICATION(S)

This application claims the benefit of Provisional Patent Application No. 61/130,438 filed May 30, 2008 for ROBOTIC MANIPULATOR

### BACKGROUND

Increasing use of precision directional sensors has added to the need for mechanical manipulators that can point objects, or workpieces, mounted thereon, such as those sensors, accurately and repeatedly anywhere in a desired workspace. Singularities in the dynamics of such manipulators, or loss of a degree-of-freedom in the workspace, due both to conditions in the physical structure or in control software used in the control system provided therefor, often impede the performance of mechanical manipulators in reaching these goals.

Many uses of these mechanical manipulators require a highly precise but limited range of motion for the manipulator in providing various desired pointings of objects mounted thereon. One such manipulator that has been used for these purposes is provided by gimbals supporting an object for pointing such as a sensor. In the past, such pointing gimbals have had a gimbal ring arrangement driven by a pair of motors. Their use requires providing therewith flexible wiring or slip-rings, or both, to supply electrical power to the mounted object, and to provide position and rate information to at least one of the drive motors. These slip-rings, or other forms of supplying electrical power and communicating information through or around objects rotating relative to each other, often result in reliability problems due to mechanical wear, aging through corrosion, and other environmental factors.

In many instances, and in particular, airborne systems such as missiles, it is very advantageous for manipulators used for pointing sensors therein in desired locations to be very compact. Not only do such manipulators need to be compact in mechanical extent but also must manipulate the sensor mounted thereon in a very compact workspace. The sensors themselves may be relatively large compared to the work envelope within which they are manipulated. This necessitates a robotic manipulator that has a relatively thin cross-section that permits operation in a confined space while at the same time manipulating a relatively bulky sensor. One reason for this limiting of the sensor motion becoming critical is due to the geometry required for the missile nose cone that is necessary for it to meet its aerodynamic performance specifications. The nose cone, for example, may incorporate a hemispherical transparent lens defining the workspace that, as indicated above, requires the motion of the sensor to track the geometry of the interior surface of that lens at a constant small separation distance such that the sensor pointing or sensing axis is maintained in directions normal to that surface.

With military aircraft becoming faster and more maneuverable, there is a corresponding increased need for faster and more maneuverable guided missiles with longer ranges to intercept such threats. These needs require both target sensors that can track targets more quickly and missile propulsion systems that can turn the missile more quickly. A way of increasing the turning rate of a missile is to use a variable position nozzle behind the rocket motor to allow the direction of thrust to be controllably varied in angle with respect to the missile longitudinal axis through redirecting the motor exhaust gases. Such a capability provides greater maneuverability than movable airfoils external to the missile alone can provide, at least under lower speed or relatively high altitude conditions when the dynamic pressure on such foils is low. A nozzle actuator system is used to variably position the nozzle and is usually located around the nozzle, and from there typically also encroaches on the remaining missile internal volume otherwise desired to be used to house supplies of rocket fuel. If the overall dimensions of the rocket motor are fixed, the smaller the nozzle actuator used, the greater the room in the missile interior volume being available for fuel tanks. Hence, the use of smaller nozzle actuators gives more internal room for fuel and so provides the missile with a greater range.

Thus, a version of the manipulator suited for use in variably positioning a sensor in the nose of the missile in the face of geometrical constraints can also be suitable to variably position a nozzle actuation system having some similar constraints. Not only do such manipulators need to be compact in mechanical extent but also must manipulate the nozzle mounted thereon in a very compact workspace. Here, too, the nozzles themselves may be relatively large compared to the work envelope within which they are manipulated. This again necessitates a robotic manipulator that has a relatively thin cross-section that permits operation in a confined space while at the same time manipulating a relatively bulky rocket nozzle. Once more, a reason for this limiting of the nozzle motion becoming critical is due to the aerodynamic limitations of the missile. The rocket motor thrust need only be directed in a small cone of motion commensurate with the velocity, mass, and other factors induced by the aerodynamic profile of the missile.

One often used arrangement utilizes a ball-and-socket based structure attached to the output of the rocket motor. The nozzle is affixed to the ball which may be rotated about the ball center in any direction. Directional control is powered by a pair of motors which drive an orthogonal pair of frames via rack and pinion gearing. These frames connect to the rocket nozzle via slots that engage a second ball formed into the nozzle diameter. Considerable material is needed to make the frames stiff. Also, a precision back-lash free fit of the frames apertures with the ball formed on the nozzle throat for precise positioning is expensive to achieve. Thus, there is desired a manipulator structural arrangement that can be used in a suitable form as a sensor manipulator and in a suitable form as a rocket nozzle manipulator.

### SUMMARY

The present invention provides a controlled relative motion system permitting a controlled motion member, joined to a base member, to selectively move with respect to the base member and having a base support and an output structure. A plurality of securing links are each rotatably connected at one end thereof to the base support and rotatably connected at an opposite end thereof to the output structure. The plurality of securing links include a fixed length securing link that is rotatably connected at one end thereof to the base support and rotatably connected at an opposite end thereof to the output structure, and further includes a variable length securing link that is rotatably connected at one end thereof to the base support and rotatably connected at an opposite end thereof to the output structure. The variable length securing link also has a rotatable capstan therewith about which a cable can be selectively wrapped or unwrapped through rotating this capstan. This cable has a capstan end thereof affixed to the capstan and an opposite end thereof affixed to the variable length securing link so that rotation of the capstan varies a separation distance between the ends of the variable length securing link. A force imparting member is coupled to the capstan and is capable of directing the capstan to vary the separation distance between the variable length securing link ends. The base support output structure can have therein at least in part a jet propulsion engine exhaust fixed portion nozzle if in a vehicle capable of motion through a fluid medium and the output structure can have therein at least in part a jet propulsion engine exhaust selectively moveable portion nozzle. The vehicle can also have therein a controlled signal processing relative motion system permitting a controlled motion electromagnetic signal receiving member, joined to a base member, to selectively move with respect to said base member.

### BRIEF DESCRIPTION OF THE DRAWINGS

FIG. 1 is a perspective view of a mechanical manipulator embodying the present invention,

FIG. 2 is another perspective view of the manipulator shown in FIG. 1,

FIG. 3 is another perspective view of the manipulator shown in FIG. 1,

FIG. 3a is an exploded view of the manipulator shown in FIG. 1,

FIG. 4 is a top view of the manipulator shown in FIG. 1,

FIG. 4a is a top view of the manipulator with the work piece removed as shown in FIG. 1,

FIG. 5 is a bottom view of the manipulator shown in FIG. 1,

FIG. 6 is a perspective view of a portion of the manipulator shown in FIG. 1,

FIG. 7 is another perspective view of a portion of the manipulator shown in FIG. 1,

FIG. 8 is a side cross section view of the manipulator shown in FIG. 1,

FIG. 9 is a portion the manipulator shown in FIG. 1 extended,

FIG. 9a is a portion the manipulator shown in FIG. 1 retracted

FIG. 10 is a top cross section view of the portion of the manipulator shown in FIG. 9,

FIG. 11 a side cross section view of the portion of the manipulator shown in FIG. 9,

FIG. 12 is a side cross section view of the portion of the manipulator shown in FIG. 9,

FIG. 13 is a perspective view of part of the portion of the manipulator shown in FIG. 9, and

FIG. 14 is an exploded view of a portion of the manipulator shown in FIG. 9.

FIG. 15 is a perspective view of a portion of the manipulator shown in FIG. 9.

FIG. 16 is a perspective view of the second embodiment of the manipulator shown in FIG. 1.

FIG. 17 is another perspective view of the second embodiment of the manipulator shown in FIG. 16.

FIG. 18 is another perspective view of the second embodiment shown in FIG. 16.

FIG. 19 is a top view of the second embodiment of the manipulator shown in FIG. 16.

FIG. 20 is a bottom view of the second embodiment of the manipulator shown in FIG. 16.

FIG. 21 is a perspective view the second embodiment of the manipulator shown in FIG. 16 showing only the actuation components.

FIG. 22 is another perspective view of the second embodiment of the manipulator shown in FIG. 16 showing only the actuation components.

FIG. 23 is a sectional view of a portion of the second embodiment of the manipulator shown in FIG. 16.

FIG. 24 is a perspective view of a portion of the second embodiment of the manipulator shown in FIG. 16.

FIG. 25 is top view of a portion of the second embodiment of the manipulator shown in FIG. 16.

FIG. 26 is a sectional view of a portion of the second embodiment of the manipulator shown in FIG. 16.

FIG. 27 is a sectional view of a portion of the second embodiment of the manipulator shown in FIG. 16.

FIG. 28 is a perspective view of a portion of the second embodiment of the manipulator shown in FIG. 16.

FIG. 29 is a perspective view of the second embodiment of the manipulator shown in FIG. 16 with the addition of aerofins.

FIG. 30 is a sectional view of a missile with the first and second embodiments of manipulator employed as a seeker gimbal and rocket nozzle actuator.

### DETAILED DESCRIPTION

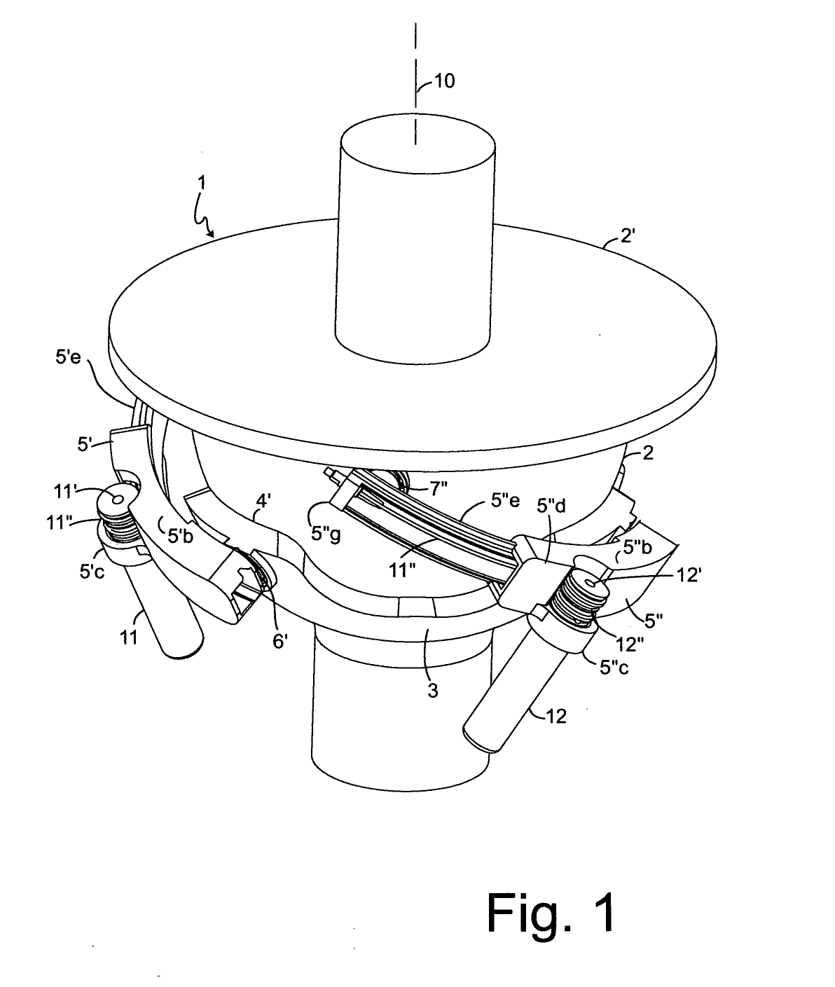

The object positioning arrangement shown in the perspective view of FIG. 1 allows an object or workpiece to be rotated to various pointings by a manipulator, 1, about a single center point of rotation that is coincident with the approximate center of an output structure, 2, and perhaps also of a workpiece, 2′, mounted thereon if mounted to also be within the open interior of that output structure. Thus, workpiece 2′, depending on its size, may be mounted above, across from, or even below the center point of rotation in the open interior of output structure 2. Alternatively, output structure 2 and workpiece 2′ may be to some extent structurally integrated through having some shared structural members. The center point of rotation is the intersection of three axes about which supporting and manipulating linking arrangements are rotatably connected to output structure 2. This configuration is particularly advantageous when manipulating workpiece object 2′, such as a sensor, which, when placed in motion by manipulator 1, must follow closely the interior surface of a lens or radome while requiring minimum lengths of wire, tubing, or fiber optic harnesses for conveying power and signals to or from that workpiece object, or both. Also, the workpiece object, again such as a sensor, may need to undergo those motions in a very compact workspace without mechanically interfering with housing or other structures positioned in the vicinity thereof.

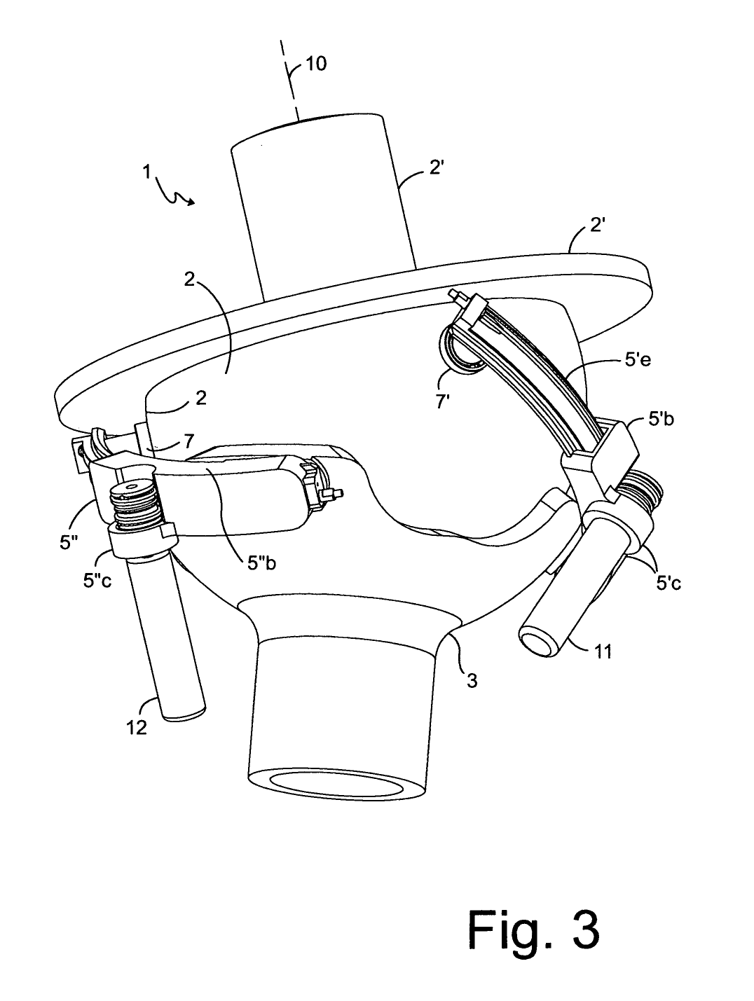

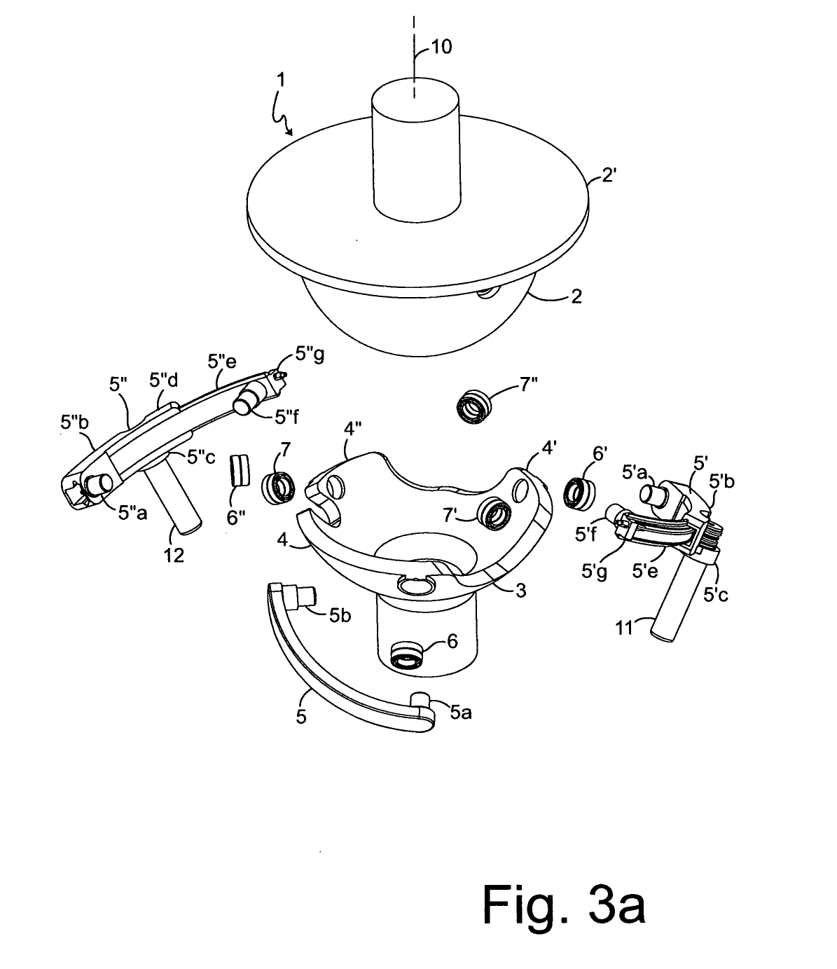

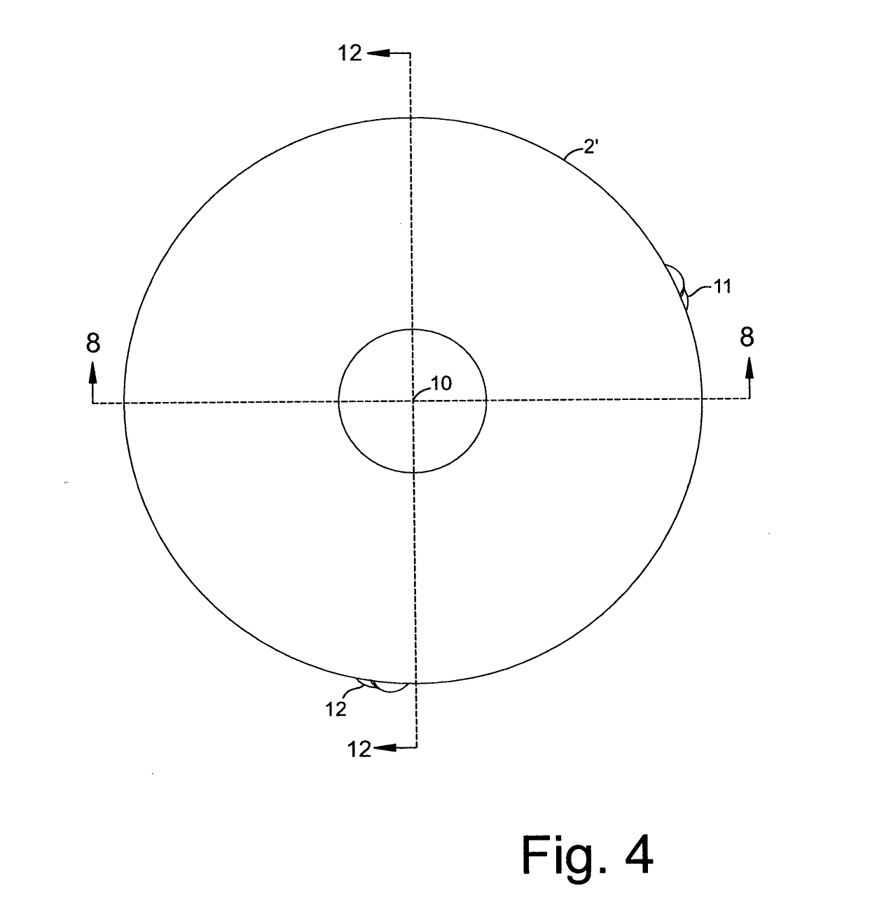

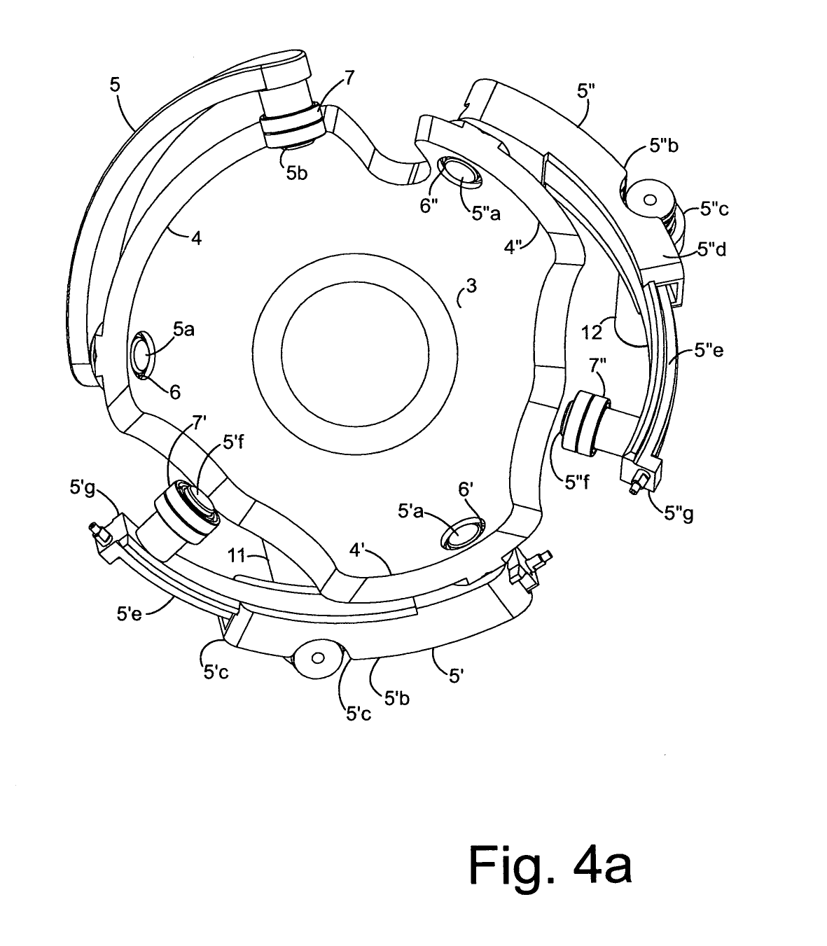

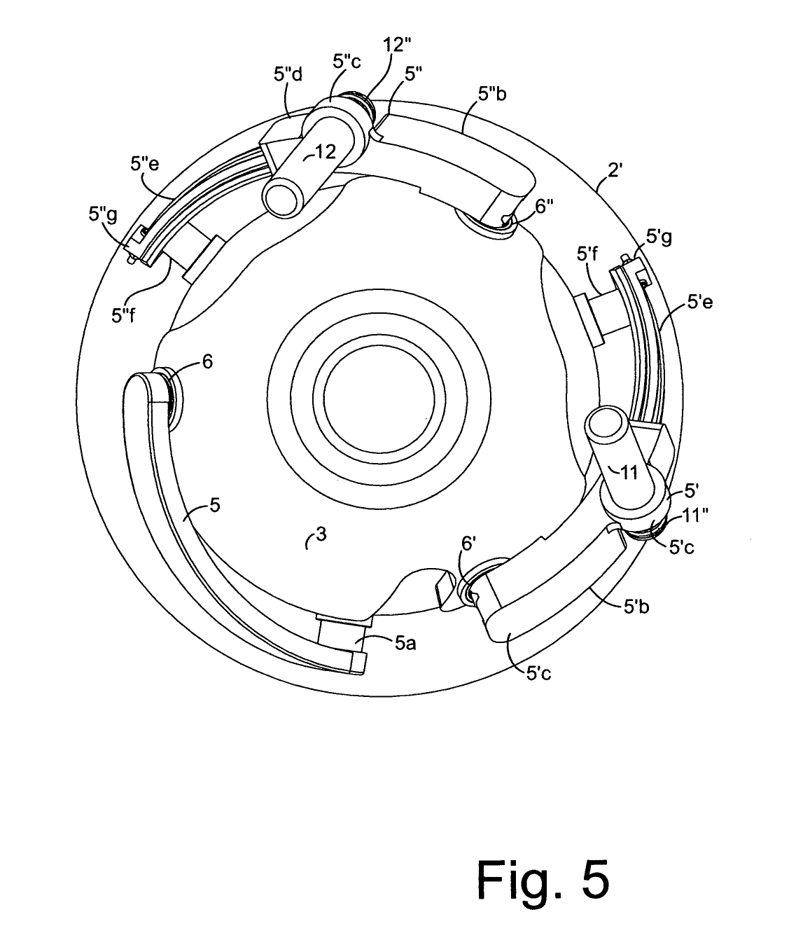

As shown in perspective views of manipulator 1 in FIGS. 1, 2 and 3 from differing vantage points, in the exploded view of FIG. 3a, in the top view thereof in FIG. 4 and the corresponding top view in FIG. 4a with output structure 2 and workpiece 2′ removed, and the bottom view thereof in FIG. 5, an interior base, 3, primarily formed as a portion of a generally hemispherical shell, or support cup, to thereby allow accommodating hemispherical output structure 2 therein, has a circular opening therethrough at approximately the center of the shell portion, and further has this shell portion extending from this circular opening therein to an outer edge thereof. This outer edge dips in three separate locations toward the circular opening to leave three separated and symmetrically positioned shell lugs, 4, 4′ and 4″, in the shell portion or cup. Shell lugs 4, 4′ and 4″ each have a corresponding opening therethrough for mounting bearings therein with these openings thereby being symmetrically spaced about the outer edge of the shell portion 3 at locations where the local tangent to the outer shell surface, parallel to the hemispherical shell portion axis of symmetry, is inclined at an angle of approximately 60° with respect to that axis.

As indicated above, there are three linking arrangements that are each rotatably connected on an end thereof to output structure 2, and they are also rotatably connected on the other end thereof to a corresponding one of the bearings mounted in the openings in shell lugs 4, 4′, and 4″. The first of these linking structures is a fixed length linking structure, 5, extending along a spatial circular arc path (not a required shape) that is rotatably connected at one end thereof to shell lug 4. The other two linking structures are compound variable length linking structures, the first of these, 5′, also extending along a spatial circular arc path (not a required shape) to be rotatably connected at one end thereof to shell lug 4′ and the second, 5″, again extending along a spatial circular arc path (not a required shape) to be rotatably connected at one end thereof to shell lug 4″.

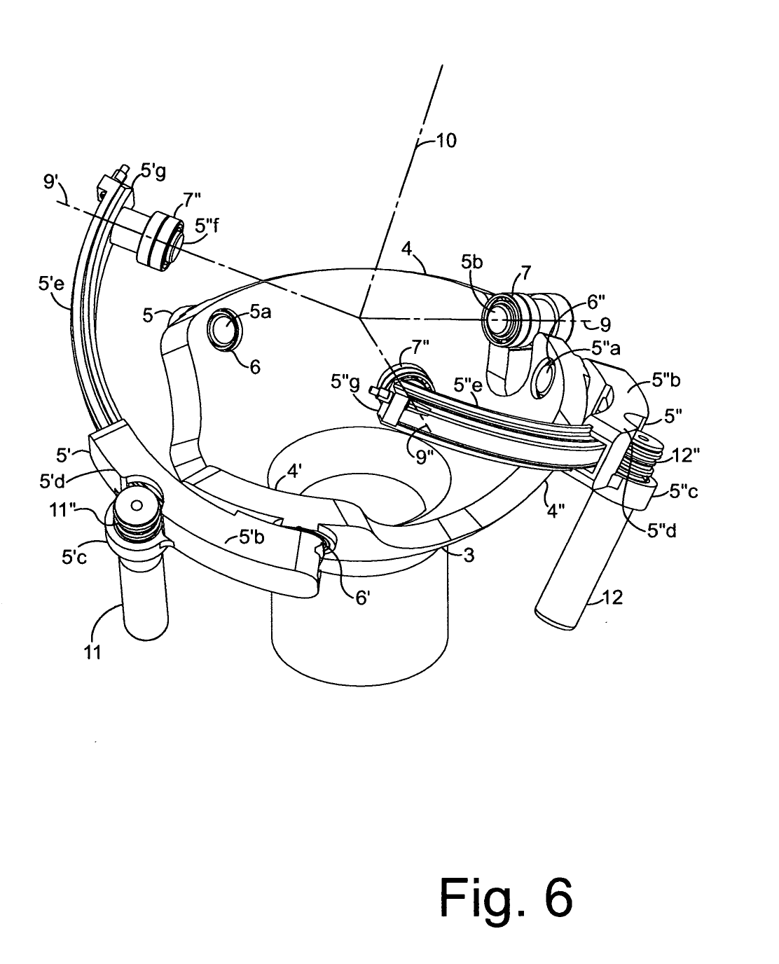

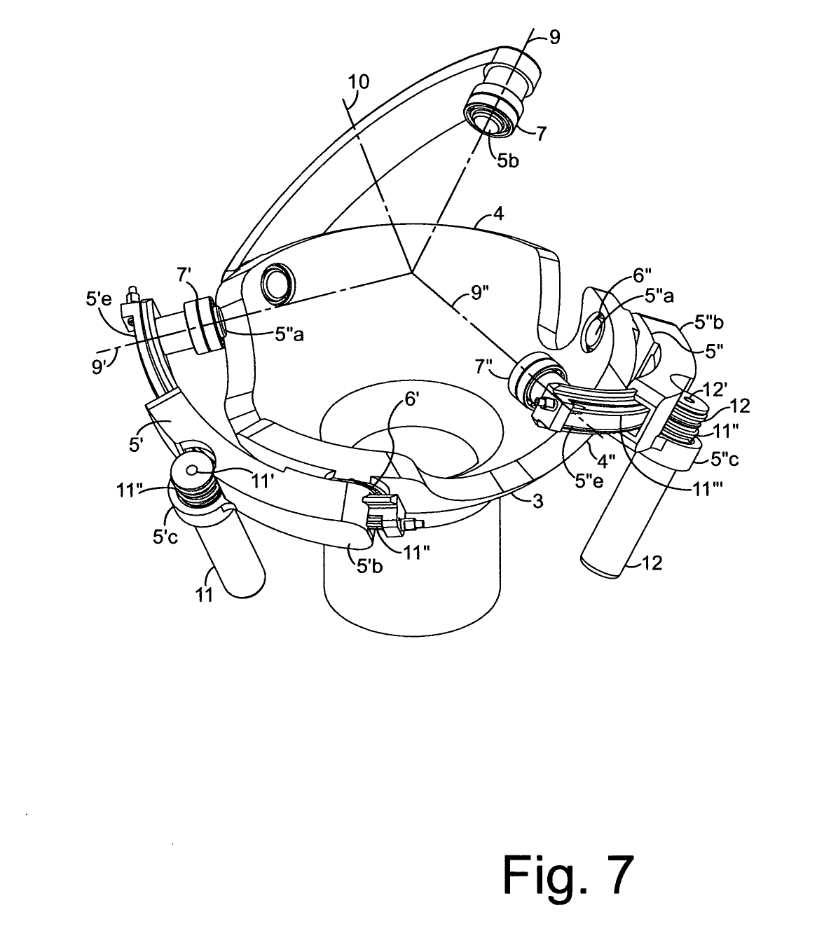

The rotatable connection between linking structure 5 and shell lug 4 of support cup 3 is provided by a circular pin, 5a, with a collar at its fixedly supported root, this pin extending from the interior of linking structure 5 at the base connected end thereof. Pin 5a is positioned in the circular opening of the inner race of a bearing, 6, with its collar against that race, this bearing having its outer race fixed in the circular opening at the top of shell lug 4 as seen in the perspective views in FIGS. 6 and 7 of manipulator 1 having the linking structures in two different positions with output structure 2 and workpiece 2′ removed therefrom.

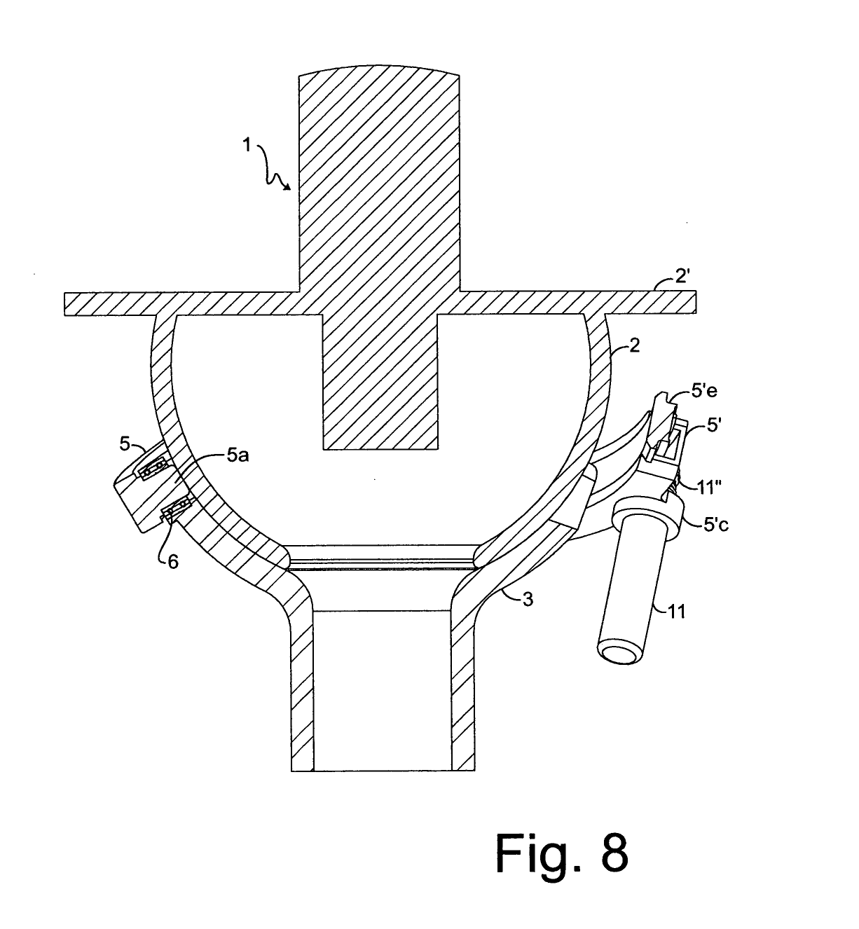

Turning to the compound linking structures, compound linking structure 5′ has a circular pin, 5′a, with a collar at its fixedly supported root, extending toward the interior of the structure from the interior surface of an outer track member, 5′b, at the base connection end of that track member. Intermediate to the opposite ends of outer track member 5′b and extending outwardly from the outer surface thereof is an enclosure, 5′c, that is formed about an open rotary force assertion space. The base connection end of outer track member 5′b has extending from it, along the spatial circular arc path followed by compound linking structure 5′, a partially enclosed track structure, 5′d, that extends to the opposite end of that member and that is enclosed about an interior track space except for a slot facing toward the interior of compound linking structure 5′. The rotatable connection between linking structure 5′ and shell lug 4′ of support cup 3 is provided by pin 5′a extending into the circular opening in the inner race of a bearing, 6′, with its collar against that race, this bearing having its outer race fixed in the circular opening at the top of shell lug 4′ as seen in FIGS. 6 and 7. A cross section view of this rotatable connection of linking structure 5′ and shell lug 4′ is shown in FIG. 8 where a side cross section view is presented corresponding to a section line, 8-8, indicated in the top view of FIG. 4.

Similarly, for the rotatable connection linking structure 5″ to shell lug 4″ of support cup 3, that linking structure has a circular pin, 5″a, with a collar at its fixedly supported root, extending toward the interior of the structure from the interior surface of an outer track member, 5″b, at the base connection end of that track member. Intermediate to the opposite ends of outer track member 5″b and extending outwardly from the outer surface thereof is an enclosure, 5″c, that is formed about an open rotary force assertion space. The base connection end of outer track member 5″b has extending from it, along the spatial circular arc path followed by compound linking structure 5″, a partially enclosed track structure, 5″d, that extends to the opposite end of that member and that is enclosed about an interior track space except for a slot facing toward the interior of compound linking structure 5″. The rotatable connection between linking structure 5″ and shell lug 4″ of support cup 3 is provided by pin 5″a extending into the circular opening in the inner race of a bearing, 6″, with its collar against that race, this bearing having its outer race fixed in the circular opening at the top of shell lug 4″. Although not seen in FIGS. 6 and 7, the foregoing rotatable connection between linking structure 5″ and shell lug 4″ is like that of the rotatable connection between linking structure 5′ and shell lug 4′.

At the other end of fixed length linking structure 5, there is another rotatable connection provided between that end of linking structure 5 and output structure 2. This rotatable connection is provided by another circular pin, 5b, with a collar at its fixedly supported root, extending from the interior of linking structure 5 at the output structure connected end thereof. Pin 5b is positioned in a circular opening in the inner race of a bearing, 7, with its collar against that race, this bearing having its outer race fixed in a circular hole in the side of hemispherical output structure 2 near the edge thereof (with this structure perhaps selected to have an outward protruding extension collar there to effectively deepen that hole) as seen to at least some extent in FIGS. 1, 2, 3, 4 and 5.

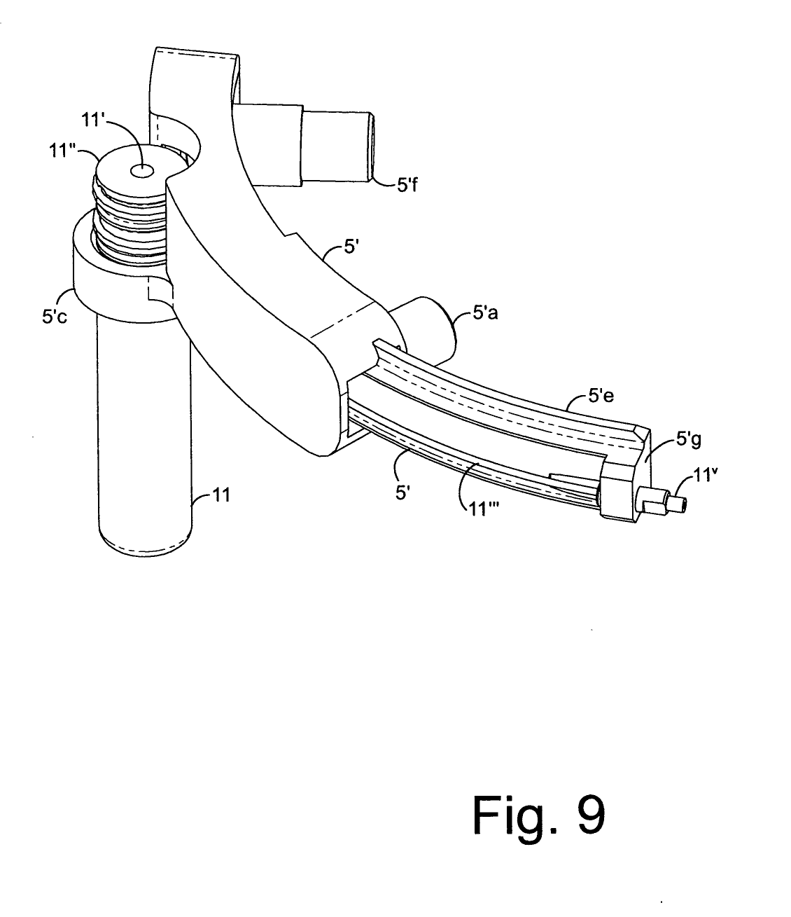

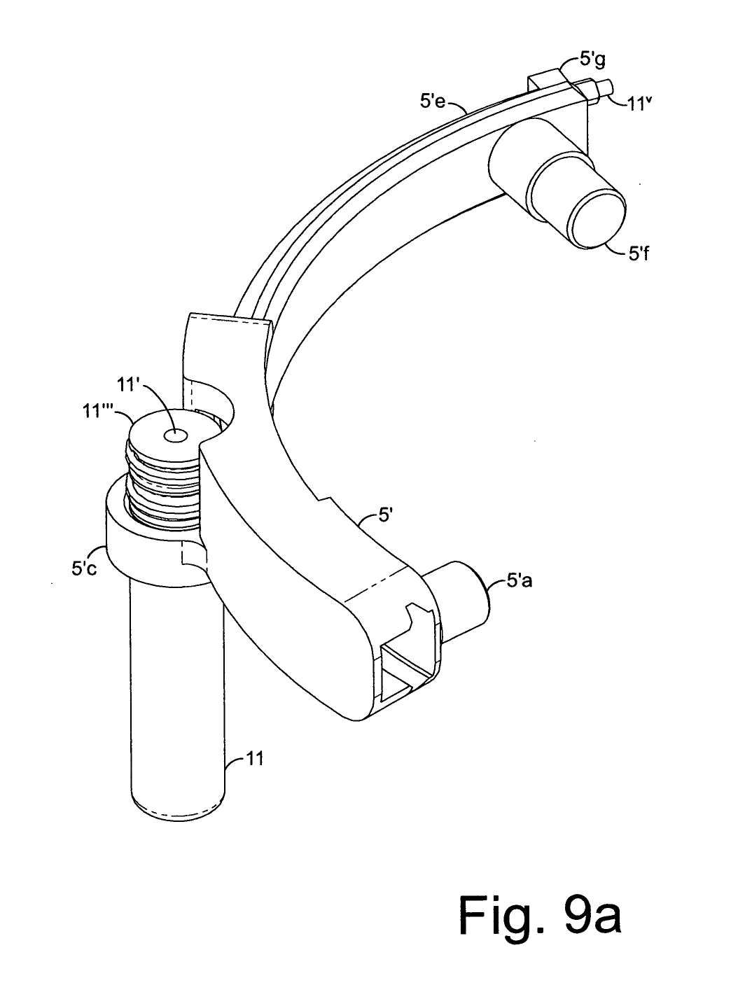

The ends of the compound linking structures opposite those described above are also rotatably connected to output structure 2. Thus, compound linking structure 5′, shown in a perspective view in FIG. 9, further has a drive strip member, 5′e, variably positionable in the rotary force assertion space and interior track space of outer track member 5′b. Drive strip member 5′e has an outer major surface on one side thereof with cable anchoring lugs at each end extending outward perpendicular to that surface, and an inner major surface on the opposite side thereof along the length of that member with each major surface extending between two grooved edges on opposite sides of these major surfaces that are grooved by each edge having a recessed channel therein along the length of that member. The inner major surface is flat between the grooved edges along the member length except for having chamfers along opposite sides thereof and except for having affixed thereat near an end a circular pin, 5′f, with a collar at its fixedly supported root, extending toward the interior of the structure and can be capable of so extending, in some relative positions, through the slot in outer track member 5′b. The outer major surface of drive strip member 5′e is flat but has the recessed channels on either side along the length thereof with cable anchoring lugs, 5′g, at each end extending outward perpendicular to that surface between those channels.

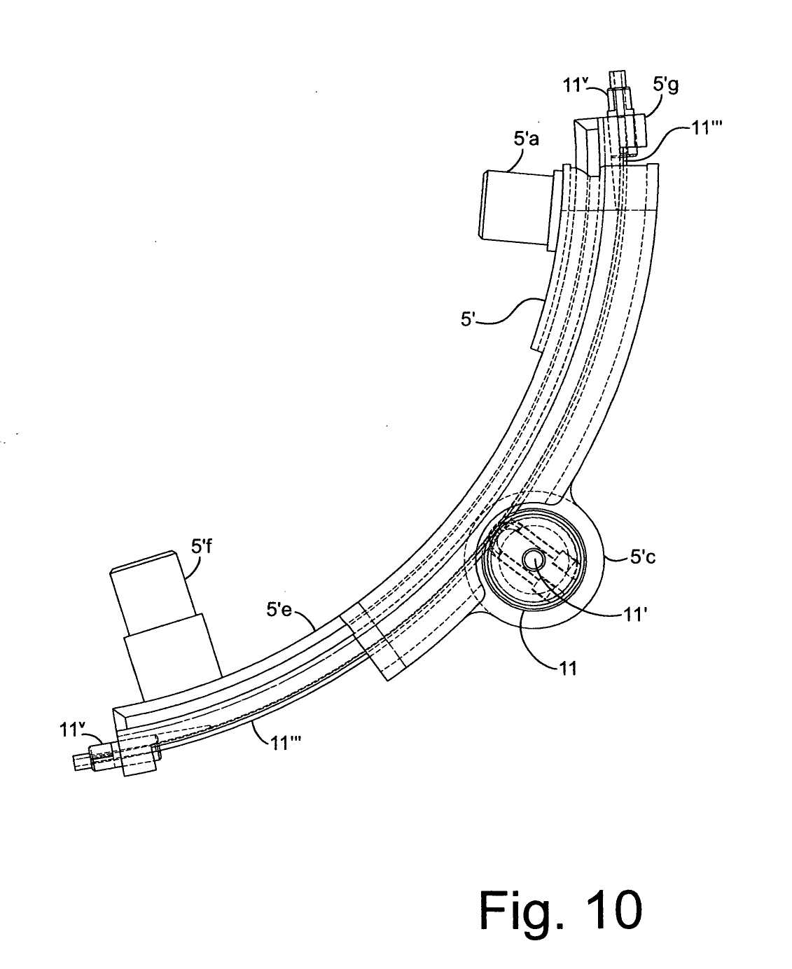

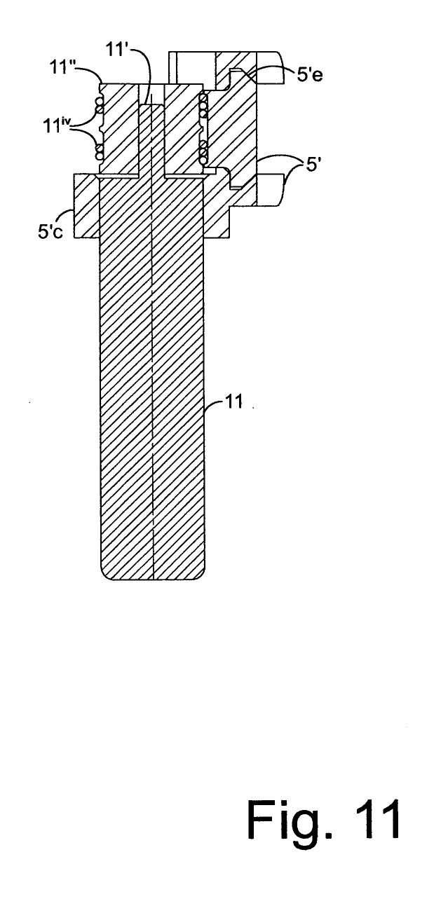

Channels on the opposite sides of the outer major surface of drive strip member 5′e, and the chamfers on the opposite sides of the inner major surface, mate with corresponding grooves in interior sides of enclosure 5′c and partially enclosed track structure 5′d of outer track member 5′b to confine the opposite edges of drive strip member 5′e in them in a precision sliding fit. A high lubricity dry coating such as Dicronite® (Tungsten Disulfide in lamellar form), provided at the mating surfaces in these corresponding grooves, enables drive strip member 5′e to be moved to various positions within the rotary force and interior track spaces of outer track member 5′b to thereby change their relative positions while encountering a much reduced sliding friction in doing so. FIG. 10 shows a top cross section view of compound linking structure 5′ with the upper sides of enclosure 5′c and partially enclosed track structure 5′d of outer track member 5′b removed to reveal the upper edge channel and the upper chamfered edge of drive strip member 5′e in the rotary force assertion space and interior track space of outer track member 5′b. FIG. 11 shows a side cross section view of enclosure 5′c with drive strip member 5′e positioned therein with the upper and lower opposite edges of the drive strip (each with a channel and a chamfer at corresponding ones of the major strip surfaces) in the mating one of the corresponding channels in the upper and lower outer walls of this enclosure.

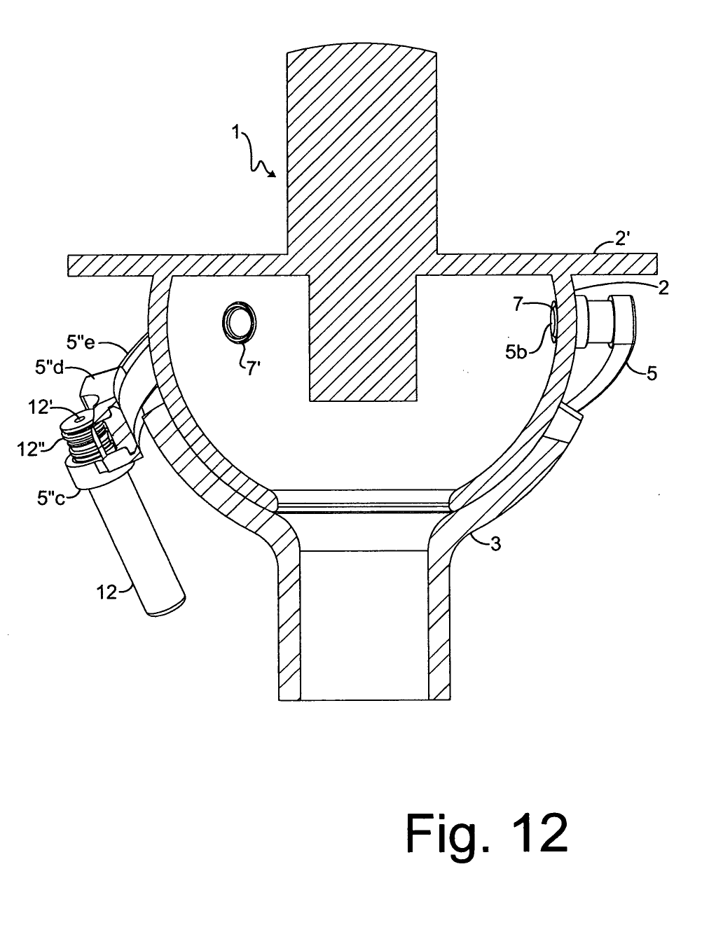

The rotatable connection between linking structure 5′ and output structure 2 is provided by pin 5′f extending into the corresponding circular opening in the inner race of a bearing, 7′, mounted in the side of hemispherical output structure 2 near its edge with its collar against that race. Bearing 7′ has its outer race fixed in a circular hole in the side of output structure 2 (with this structure perhaps selected to have an outward protruding extension collar there to effectively deepen that hole) as seen to at least some extent in FIGS. 1, 4 and 5. A more complete showing is provided in the side cross section view of manipulator 1 in FIG. 12 which corresponds to a section line, 12-12, indicated in the top view of FIG. 4 which is rotated from section line 8-8 of that figure leading to the view in FIG. 12 being rotated approximately 90° along the vertical from the view shown thereof in FIG. 8.

Similarly, compound linking structure 5″ further has a drive strip member, 5″e, variably positionable in the rotary force assertion space and interior track space of outer track member 5″b. Drive strip member 5″e has an outer major surface on one side thereof and an inner major surface on the opposite side thereof along the length of that member with each major surface extending between two grooved edges on opposite sides of these major surfaces that are grooved by each edge having a recessed channel therein along the length of that member. The inner major surface is flat between the grooved edges along the member length except for having chamfers along opposite sides thereof and except for having affixed thereat near an end a circular pin, 5″f, with a collar at its fixedly supported root, extending toward the interior of the structure and can be capable of so extending, in some relative positions, through the slot in outer track member 5″b. The outer major surface of drive strip member 5″e is flat but has the recessed channels on either side along the length thereof with cable anchoring lugs, 5″g, at each end extending outward perpendicular to that surface between those channels.

Channels on the opposite sides of the outer major surface of drive strip member 5″e, and the chamfers on the opposite sides of the inner major surface, mate with corresponding grooves in interior sides of enclosure 5″c and partially enclosed track structure 5″d of outer track member 5″b to confine the opposite edges of drive strip member 5″e in them in a precision sliding fit. A high lubricity dry coating such as Dicronite® (Tungsten Disulfide in lamellar form), provided at the mating surfaces in these corresponding grooves, enables drive strip member 5″e to be moved to various positions within the rotary force and interior track spaces of outer track member 5″b to thereby change their relative positions while encountering a much reduced sliding friction in doing so. The arrangement shown for linking structure 5′ in FIGS. 9, 10 and 11 is also followed for linking structure 5″.

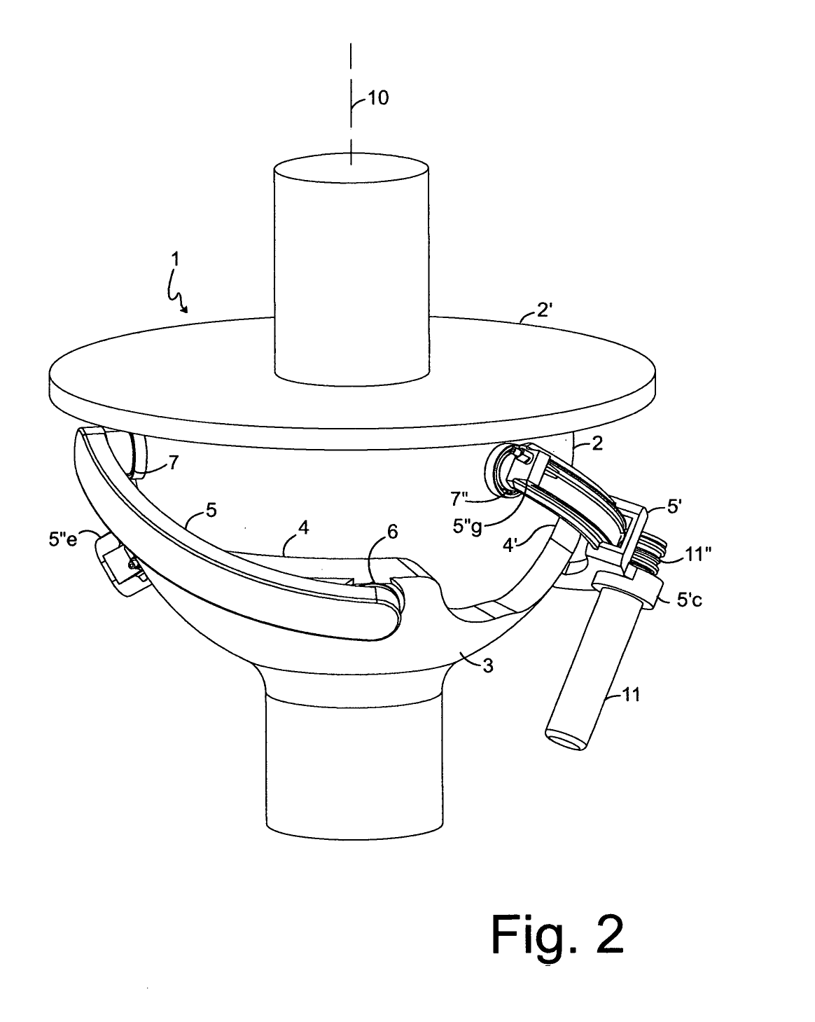

The rotatable connection between linking structure 5″ and output structure 2 is provided by pin 5″f extending into the corresponding circular opening in the inner race of a bearing, 7″, mounted in the side of hemispherical output structure 2 near its edge with its collar against that race. Bearing 7″ has its outer race fixed in a circular hole in the side of output structure 2 (with this structure perhaps selected to have an outward protruding extension collar there to effectively deepen that hole) as seen to at least some extent in FIGS. 2, 4 and 5.

The axes of rotations of output structure 2 about circular pins 5b, 5′f and 5″f are indicated by dashed lines, 9, 9′ and 9″ in the figures where they are shown corresponding to those pins (see FIGS. 6 and 7, for example), these axes shown meeting at a common point. A dashed line output axis, 10, symmetrically positioned with respect to circular pins 5b, 5′f and 5″f and rotation axes 9, 9′ and 9″, as well as being positioned symmetrically with respect to workpiece 2′, is also shown in the figures corresponding to those pins and axes to thereby result in axis 10 extending from the common intersection point of rotation axes 9, 9′ and 9″.

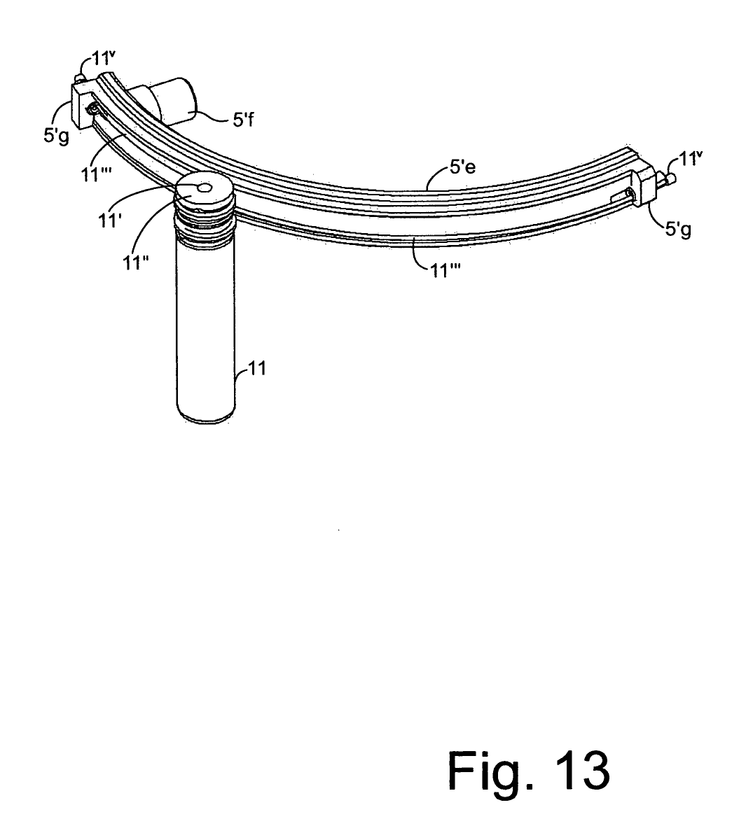

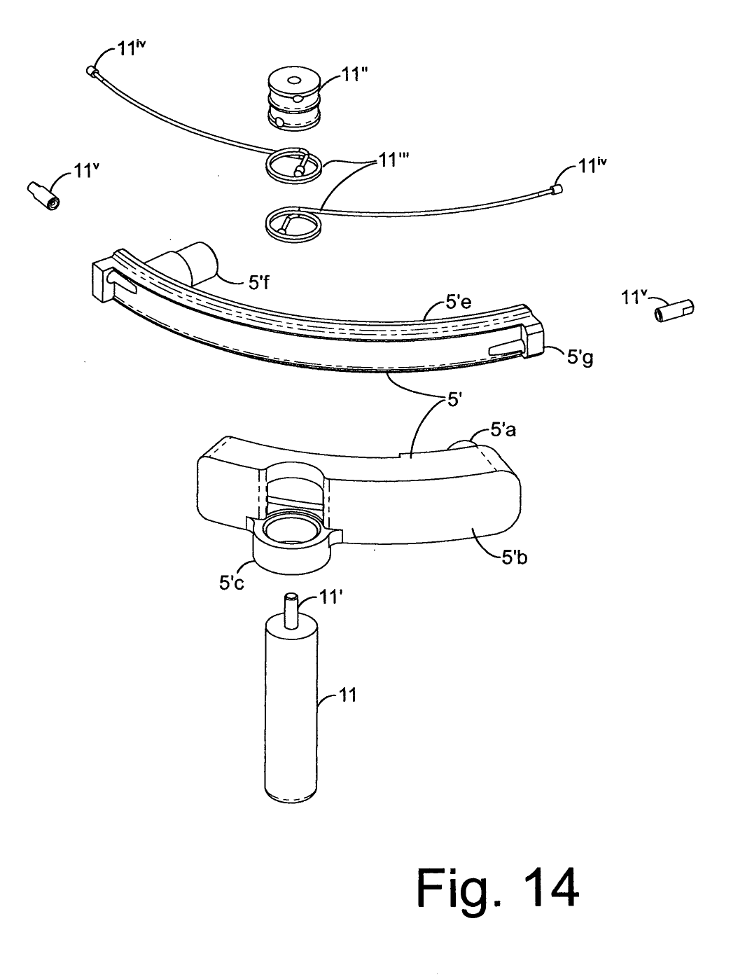

As seen in many of the figures, there is a pair of electric motors, 11 and 12, that can be used to cause compound linking structures 5′ and 5″, respectively, to undergo a change in their lengths along the length variation paths followed thereby under control of a double cable positioning control system to thereby set the orientation of axis 10. Thus, motor 11 is mounted on enclosure 5′c so as to have an output shaft, 11′, thereof extend into that enclosure to have a double capstan, 11″, in the enclosure affixed thereto so that it can be rotated in either direction. Though, as indicated, this arrangement is seen in many of the figures, it is best seen in FIGS. 9, 10 and 11 and is further shown in the perspective view of FIG. 13 and an exploded view in FIG. 14.

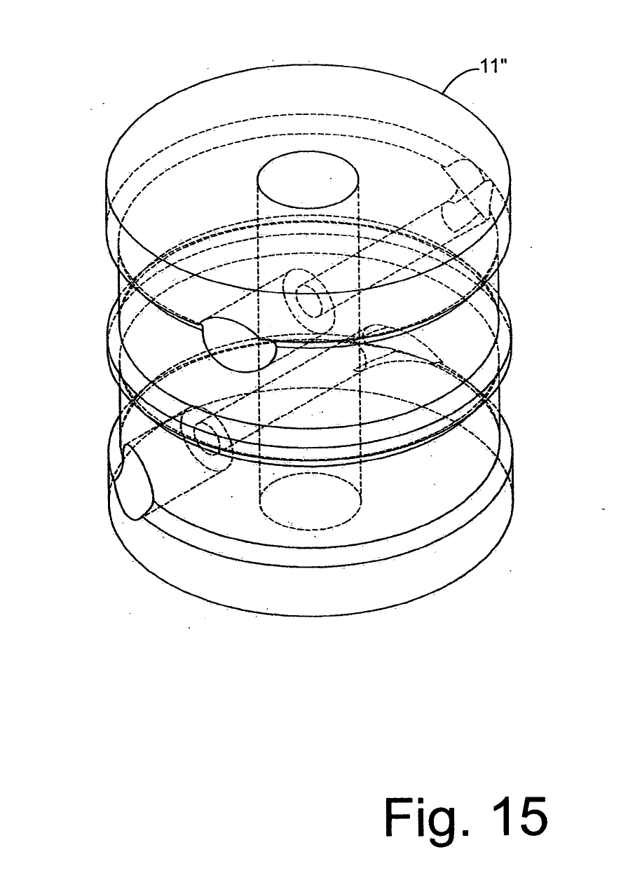

Double capstan 11″ has an outer surface formed by two concentric, circumferential channels adjacent one another in being separated from each other by an intervening circular ridge as seen in FIG. 15, there being a cable anchoring hole provided in each. Each of two cables, 11′″, is affixedly anchored at one end thereof in the hole in a corresponding one of these capstan channels and wrapped about its channel in a direction opposite that of the other. The opposite ends of each of cables 11′″ are each affixed within the hollow of a hollow exteriorly threaded cylindrical bolt, 11^{iv}, and the cables each extend from its channel in capstan 11″ in opposite directions along the outer major surface of drive strip member 5′e to a corresponding one of its opposite ends, and there through a hole in the corresponding end cable anchoring lug 5′g. An interiorly threaded nut, 11^{v}, is provided engaged with the threaded cylindrical bolt extending through this anchoring lug hole to fasten that bolt, and cable end affixed therein, in that lug under tension set by the degree of tightening of the nut on this bolt to thereby reduce or eliminate backlash upon the capstan changing rotation directions.

Thus, selectively rotating double capstan 11″ with motor 11 thereby allows variably positioning drive strip member 5′e in the rotary force assertion space and interior track space of outer track member 5′b relative to member 5′b through the force applied on cables 11′″ anchored to the ends of drive strip member 5′e with one cable being wound around the capstan while the other is unwound therefrom. That is, drive strip member 5′e is forced to move with respect to outer track member 5′b so as to either increase or decrease the separation distance between circular pin 5′f and circular pin 5′a depending on the direction of rotation selected for motor 11 to rotate double capstan pulley 11″. An increase in the separation distance results in linking structure 5′ pushing output structure 2 away from shell lug 4′, and decreasing that distance results in linking structure 5′ pulling them toward one another, thereby, in either instance, changing the spatial orientation of output axis 10 through rotations of output structure 2 about some or all of axes 9, 9′ and 9″.

Similarly, motor 12 is mounted on enclosure 5″c so as to have an output shaft, 12′, thereof extend into that enclosure to have a double capstan, 12″, in the enclosure affixed thereto so that it can be rotated in either direction. As indicated, this arrangement for motor 12 changing the length of linking structure 5″ is seen in many of the figures and follows the same arrangement used for motor 11 changing the length of linking structure 5′.

Double capstan 12″ again has an outer surface formed by two concentric, circumferential channels adjacent one another in being separated from each other by an intervening circular ridge with there being a cable anchoring hole provided in each. Here, too, each of two cables, 12′″, is affixedly anchored at one end thereof in the hole in a corresponding one of these capstan channels and wrapped about its channel in a direction opposite that of the other. The opposite ends of each of cables 12′″ are each affixed within the hollow of a hollow exteriorly threaded cylindrical bolt, 12^{iv}, and the cables each extend from its channel in capstan 12″ in opposite directions along the outer major surface of drive strip member 5″e to a corresponding one of its opposite ends, and there through a hole in the corresponding end cable anchoring lug 5″g. An interiorly threaded nut, 12^{v}, is provided engaged with the threaded cylindrical bolt extending through this anchoring lug hole to fasten that bolt, and cable end affixed therein, in that lug under tension set by the degree of tightening of the nut on this bolt to thereby reduce or eliminate backlash upon the capstan changing rotation directions.

Hence, here too, in this arrangement, selectively rotating double capstan 12″ with motor 12 thereby allows variably positioning drive strip member 5″e in the rotary force assertion space and interior track space of outer track member 5″b relative to member 5″b through the force applied on cables 12′″ anchored to the ends of drive strip member 5″e with, as before, one cable being wound around the capstan while the other is unwound therefrom. Drive strip member 5″e is thereby forced to move with respect to outer track member 5″b so as to either increase or decrease the separation distance between circular pin 5″f and circular pin 5″a depending on the direction of rotation selected for motor 12 to rotate double capstan pulley 12″. An increase in the separation distance results in linking structure 5″ pushing output structure 2 away from shell lug 4″, and decreasing that distance results in linking structure 5″ pulling them toward one another, thereby, in either instance, changing the spatial orientation of output axis 10 through rotations of output structure 2 about some or all of axes 9, 9′ and 9″.

These motions of the drive strip members with respect to the corresponding one of the outer track members more or less containing it can be coordinated through the selective operations of motors 11 and 12 to position output axis 10 as desired in a conical workspace. Fixed length linking structure 5 is correspondingly forced to move by the resulting movement of output structure 2 with respect to shell lug 4. In doing so, linking structure 5 stabilizes the motion of output structure 2 by limiting the range of motions otherwise available to output structure 2 in being rotated by motors 11 and 12. If the user is willing to accept a reduced range of motion in orienting axis 10, one of motors 11 and 12 can be kept in a fixed position, or eliminated altogether by substituting a fixed length linking structure for the compound linking structure associated with that motor.

FIGS. 6 and 7 show two different positions of output axis 10 with, in FIG. 6, both of linking structures 5′ and 5″ being relatively extended to thereby provide relatively larger pins separation distances and forcing linking structure 5, as a result, to keep the location on output structure 2 to which it is rotatably connected relatively close to base 3 to thereby tilt that output structure relatively toward that connection location. In FIG. 7, in contrast, both of linking structures 5′ and 5″ are relatively short and so linking structure 5, as a result, forces the location on output structure 2 to which it is rotatably connected to move upward relatively farther from base 3 to thereby tilt that output structure more toward a location halfway between the rotatable connections of linking structures 5′ and 5″ thereto. Increasing the length of one of linking structures 5′ and 5″ while decreasing the length of the other will move output axis 10 to one side or the other of the plane that axis followed in responding to the joint lengthening and shortening of those linking structures described just above.

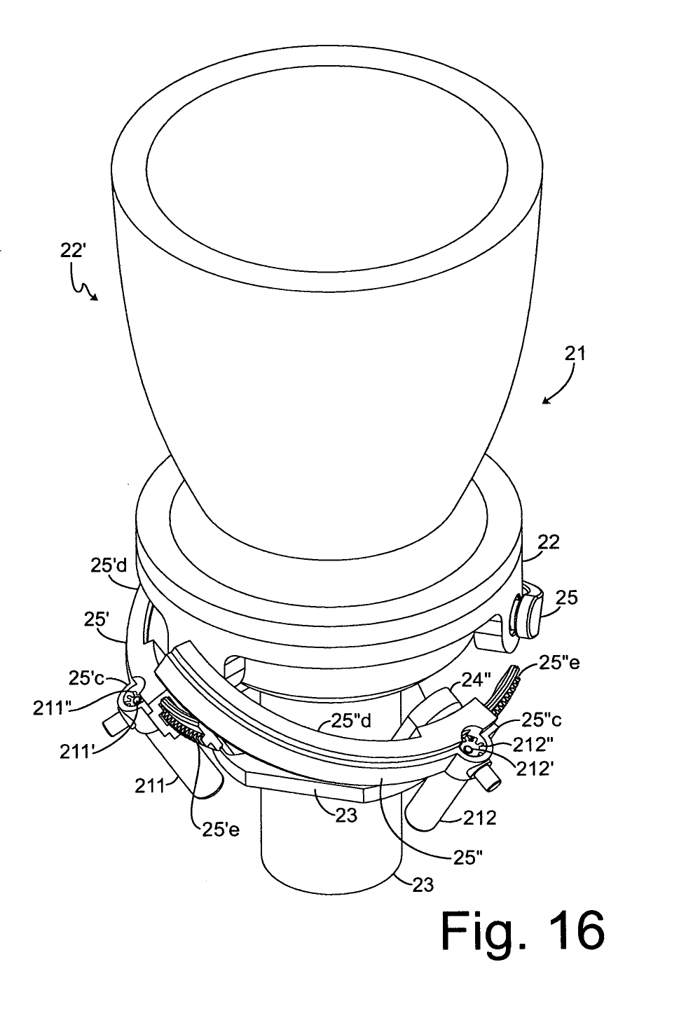

The object positioning arrangement shown in the perspective view of FIG. 16 allows the positioning of a rocket nozzle or other jet propulsion engine for thrust vector control. There is a considerable cost reduction in design and fabrication costs resulting from the use of a similar design for manipulation of both a sensor workpiece and a rocket motor nozzle workpiece used together in the same missile. Several individual components which are employed in one positioner may be employed in the other, thereby reducing not only the cost of manufacturing parts but also simplifying the logistical support with spare parts inventory, maintenance and other aspects that contribute to overall system cost.

This arrangement in FIG. 16 allows placing an object or workpiece to be rotated to various pointings by a manipulator, 21, about a single center point of rotation that is coincident with the approximate center of an output structure, 22, and perhaps also of a workpiece, 22″, mounted thereon (shown as a rocket motor nozzle in the figure) if mounted to also be within the open interior of that output structure. Thus, workpiece 22′, depending on its size, may be mounted above, across from or even below the center point of rotation in the open interior of output structure 22. Alternatively, output structure 22 and workpiece 22′ may be to some extent structurally integrated through having some shared structural members. The center point of rotation is the intersection of three axes about which output structure, supporting and manipulating linking arrangements are rotatably connected to output structure 22. This configuration is particularly advantageous when manipulating workpiece object 22′, such as a rocket motor nozzle, which, when placed in motion by manipulator 21, must follow a motion about a single center point, and withstand significant loads caused by the rocket motor thrust. Also, the workpiece object, again such as a rocket motor nozzle, may need to undergo those motions in a very compact workspace without mechanically interfering with housing or other structures positioned in the vicinity thereof.

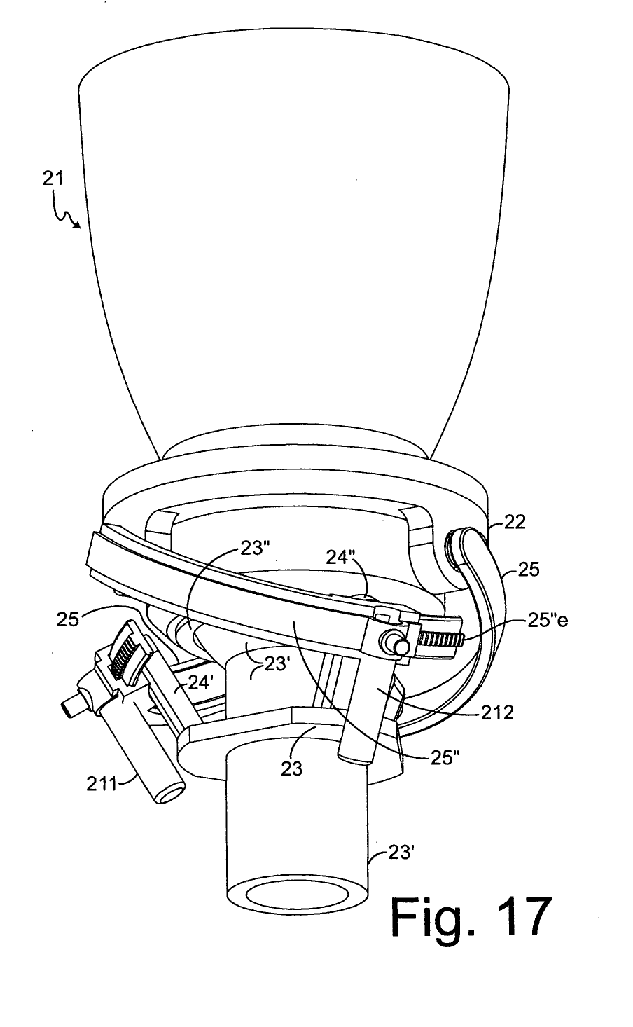

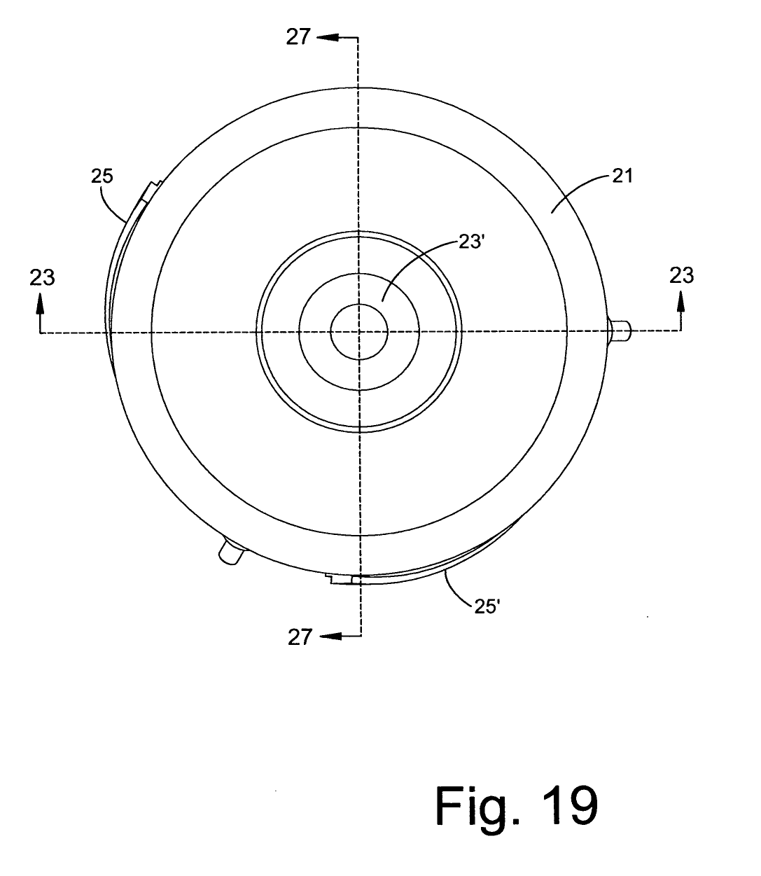

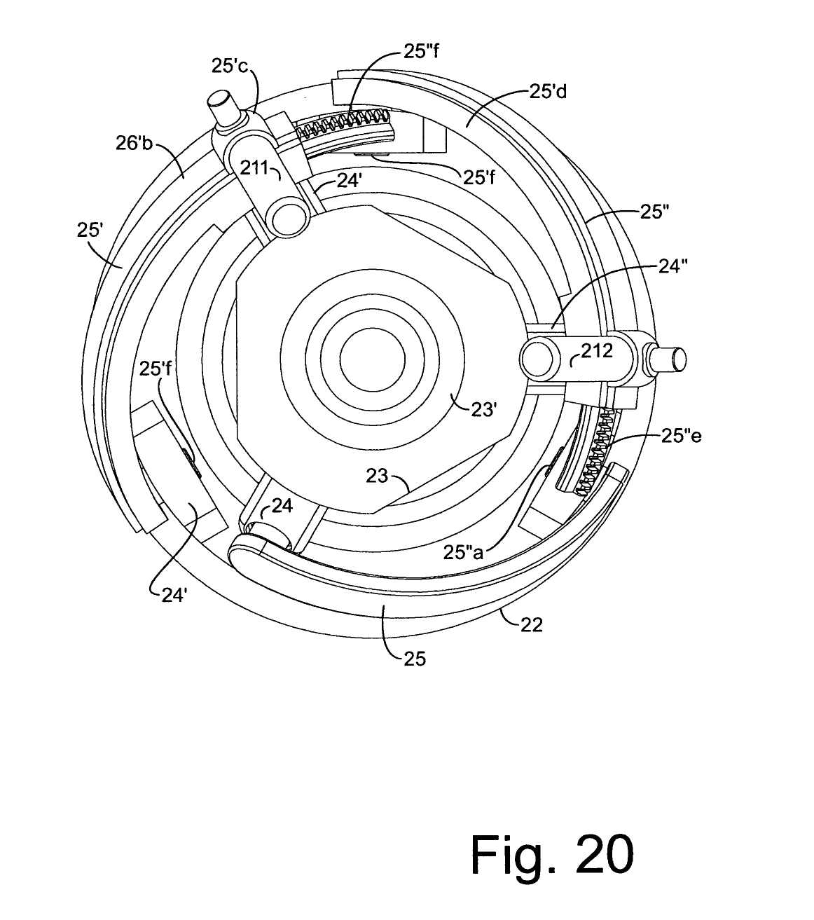

As shown in perspective views of manipulator 21 in FIGS. 16, 17 and 18 from differing vantage points, and in the top view thereof in FIG. 19 and the bottom view thereof in FIG. 20, a manipulator base, 23, is primarily formed of a circular ring with a circular center opening therethrough. Through this circular opening in base 23 extends a rocket motor exhaust nozzle ducted hemispherical support, 23′, on which the hemispherically hollowed base portion of rocket motor nozzle workpiece 22′ is supported and over which it slides in having the remaining main nozzle portion directed to various alternative orientations by manipulator 21. At the end of the hemispherically hollowed base portion of rocket motor nozzle workpiece 22′ farthest from the main nozzle portion, a retaining and sealing ring, 23″, is provided between that hemispherically hollowed base portion and the hemispherical portion of rocket motor exhaust nozzle ducted hemispherical support 23′.

Manipulator base 23 has affixed thereto, at an upper ring surface and at symmetrically spaced locations thereon near the ring outer periphery, three support standards, 24, 24′ and 24″. Each extends upward and outward from the interior base primary ring at an angle of approximately 30° with respect to the plane of that primary ring, and has a circular opening at the top thereof to accommodate a circular bearing arrangement or bushing.

As indicated above, there are three linking arrangements that are each rotatably connected on an end thereof to output structure 22, and they are rotatably connected on the other end thereof to a corresponding one of support standards 24′, 24″ and 24″. The first of these linking structures is a fixed length linking structure, 25, extending along a spatial circular arc path (not a required shape) that is rotatably connected at one end thereof to support standard 24. The other two linking structures are compound variable length linking structures, the first of these, 25′, also extending along a spatial circular arc path (not a required shape) to be rotatably connected at one end thereof to support standard 24′ and the second, 25″, again extending along a spatial circular arc path (not a required shape) to be rotatably connected at one end thereof to support standard 24″.

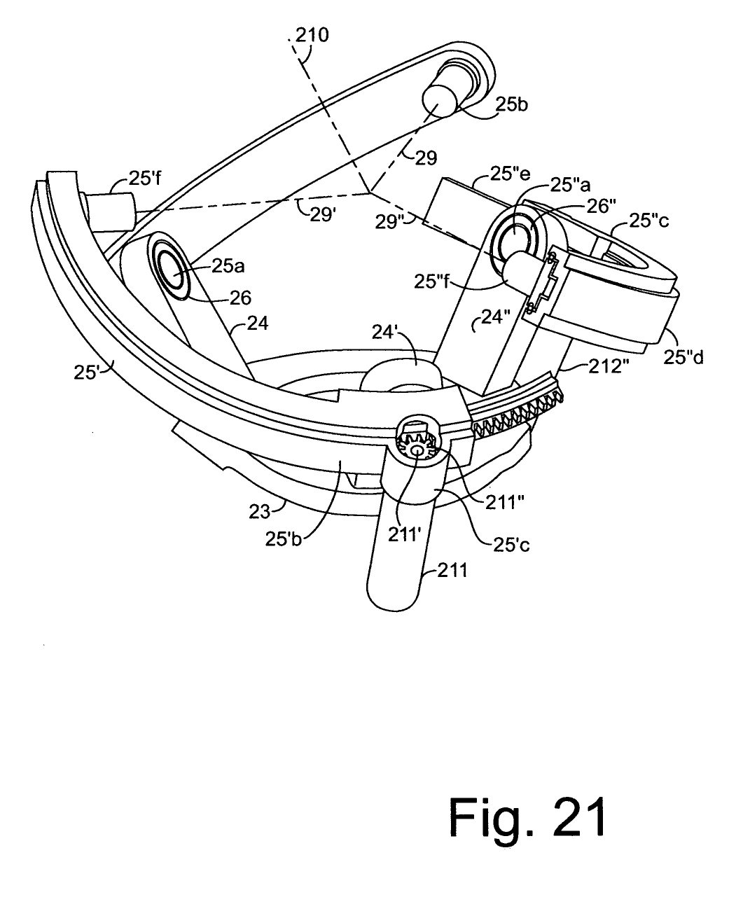

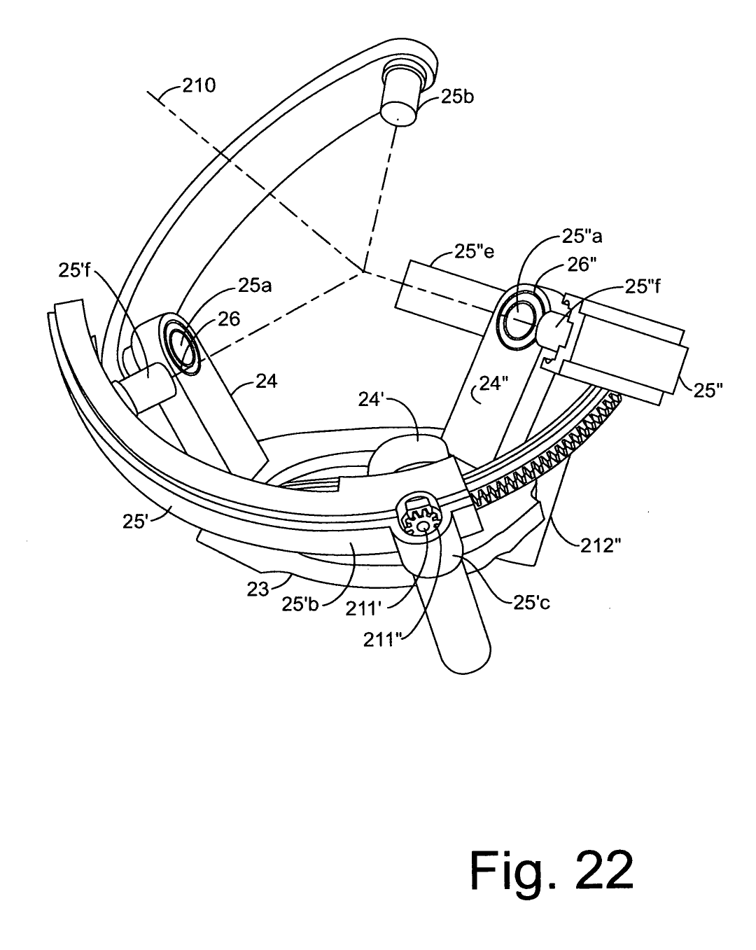

The rotatable connection between linking structure 25 and support standard 24 is provided by a circular pin, 25a, with a collar at its fixedly supported root, this pin extending from the interior of linking structure 25 at the base connected end thereof. Pin 25a is positioned in the circular opening of the inner race of a bearing, 26, with its collar against that race, this bearing having its outer race fixed in the circular opening at the top of support standard 24 as seen in the perspective views in FIGS. 21 and 22 of manipulator 21 having the linking structures in two different positions with output structure 22 and workpiece 22′ removed therefrom.

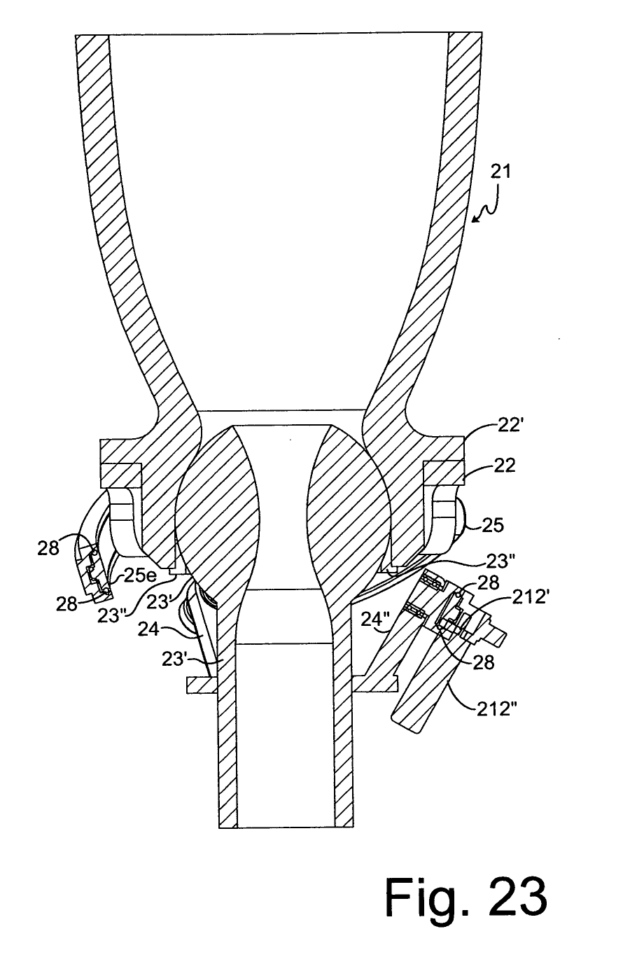

Turning to the compound linking structures, compound linking structure 25′ has a circular pin, 25′a, with a collar at its fixedly supported root, extending toward the interior of the structure from an outer track member, 25′b, thereof at an outer wall of an enclosure, 25′c, therein at the base connection end of that track member which enclosure is formed about an open rotary force assertion space. Enclosure 25′c of outer track member 25′b has extending from it, along the spatial circular arc path followed by compound linking structure 25′, a partially enclosed track structure, 25′d, that is enclosed about an interior track space except for a slot facing toward the interior of compound linking structure 25′. The rotatable connection between linking structure 25′ and support standard 24′ is provided by pin 25′a extending into the circular opening in the inner race of a bearing, 26′, with its collar against that race, this bearing having its outer race fixed in the circular opening at the top of support standard 24′ as seen in FIGS. 21 and 22. A cross section view of this rotatable connection of linking structure 25′ and support standard 24′ is shown in FIG. 23 where a side cross section view is presented corresponding to a section line, 23-23, indicated in the top view of FIG. 19.

Similarly, for the rotatable connection linking structure 25″ to support standard 24″, that linking structure has a circular pin, 25″a, with a collar at its fixedly supported root, extending toward the interior of the structure from an outer track member, 25″b, thereof at an outer wall of an enclosure, 25″c, therein at the base connection end of that track member which enclosure is formed about an open rotary force assertion space. Enclosure 25″c of outer track member 25″b has extending from it, along the spatial circular arc path followed by compound linking structure 25″, a partially enclosed track structure, 25″d, that is enclosed about an interior track space except for a slot facing toward the interior of compound linking structure 25″. The rotatable connection between linking structure 25″ and support standard 24″ is provided by pin 25″a extending into the circular opening in the inner race of a bearing, 26″, with its collar against that race, this bearing having its outer race fixed in the circular opening at the top of support standard 24″. Although not seen in FIGS. 21 and 22, the foregoing rotatable connection between linking structure 25″ and support standard 24″ is like that of the rotatable connection between linking structure 25′ and support standard 24′.

At the other end of fixed length linking structure 25, there is another rotatable connection provided between that end of linking structure 25 and output structure 22. This rotatable connection is provided by another circular pin, 25b, with a collar at its fixedly supported root, extending from the interior of linking structure 25 at the output structure connected end thereof. Pin 25b is positioned in a circular opening in the inner race of a bearing, 27, with its collar against that race, this bearing having its outer race fixed in a circular hole in the side of output structure 22 as seen to at least some extent in FIGS. 16, 17, and 18.

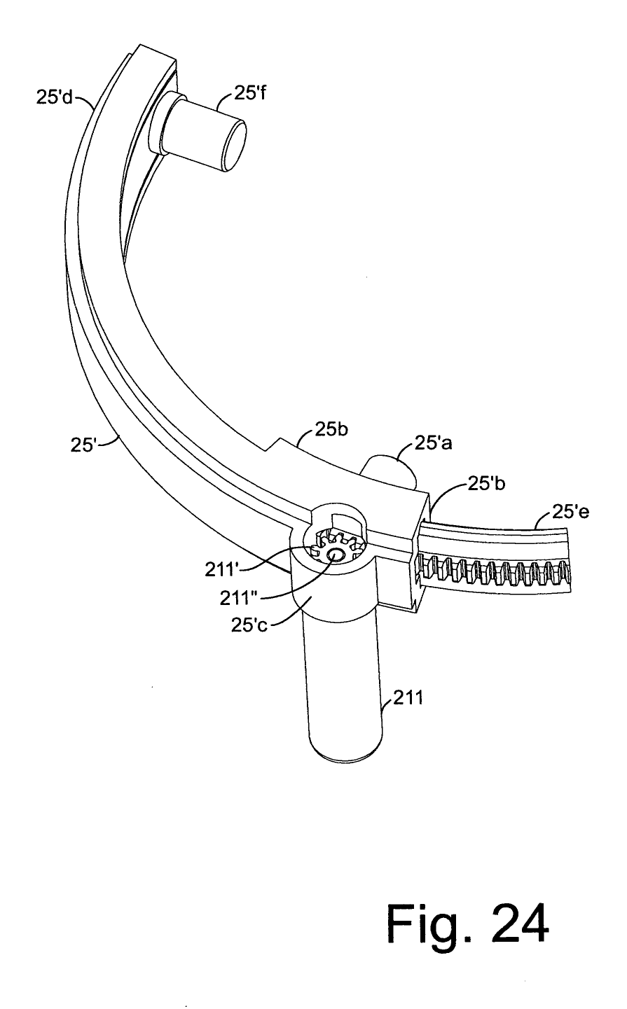

The ends of the compound linking structures opposite those described above are also rotatably connected to output structure 22. Thus, compound linking structure 25′, shown in a perspective view in FIG. 24, further has a rack strip member, 25′e, variably positionable in the rotary force assertion space and interior track space of outer track member 25′b. Rack strip member 25′e has an outer major surface on one side thereof and an inner major surface on the opposite side thereof along the length of that member with each major surface extending between two grooved edges on opposite sides of these major surfaces that are grooved by each edge having a recessed channel therein along the length of that member. The outer major surface of rack strip member 25′e has gear teeth symmetrically positioned between the grooved edges thereof along the length of that member, and the inner major surface is flat between the grooved edges along the member length except for having affixed thereat a circular pin, 25′f, with a collar at its fixedly supported root, extending toward the interior of the structure and can be capable of so extending, in some relative positions, through the slot in outer track member 25′b.

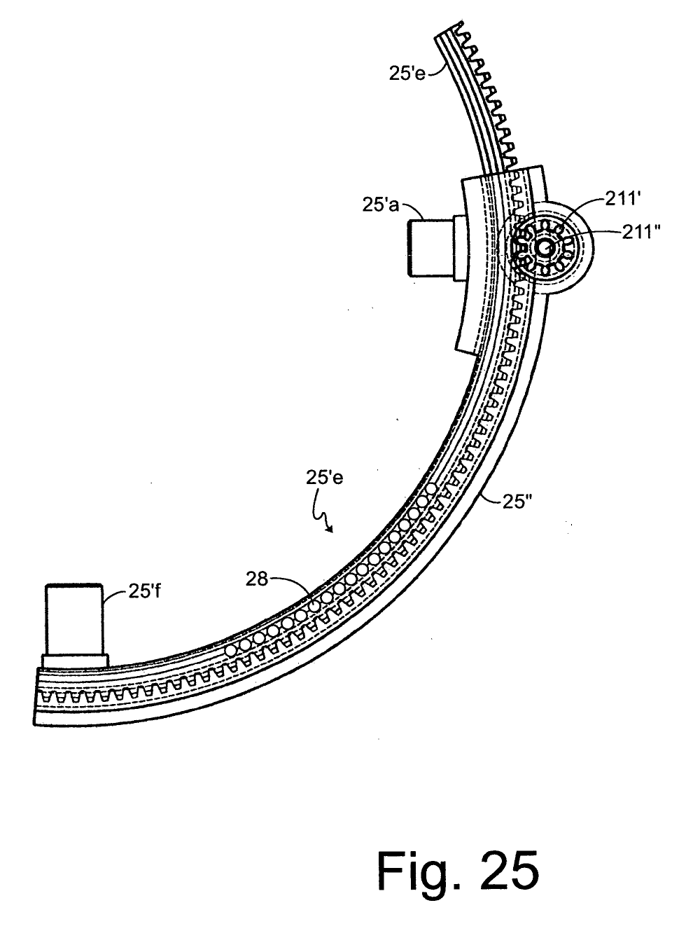

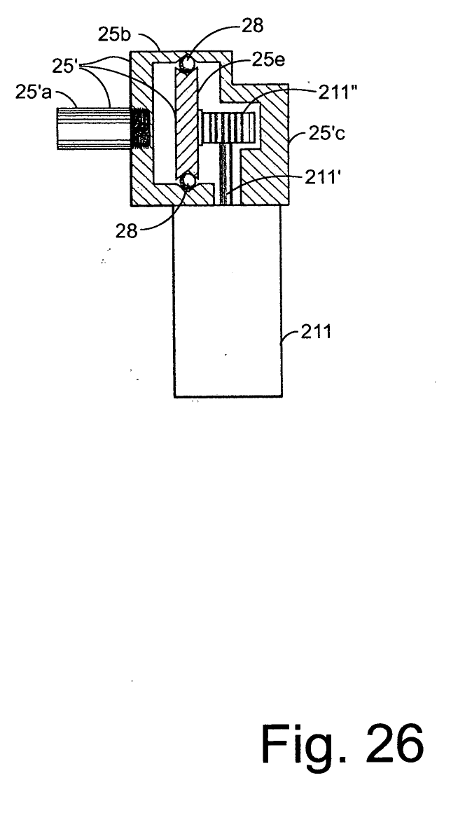

A plurality of ball bearings, 28, are trapped in the channels of the grooved edges of rack strip member 25′e by the interior sides of enclosure 25′c and partially enclosed track structure 25′d of outer track member 25′b which also have channels therein across from those of the grooved edges to aid in trapping ball bearings 28. Ball bearings 28 are otherwise free to rotate in those channels to thereby enable rack strip member 25′e to be moved to various positions within outer track member 25′b with much reduced friction in doing so. FIG. 25 shows a top cross section view of compound linking structure 25′ with the upper sides of enclosure 25′c and partially enclosed track structure 25′d of outer track member 25′b removed to reveal the upper grooved edge of rack strip member 25′e in the rotary force assertion space and interior track space of outer track member 25′b, and with ball bearings 28 in the channel in the revealed grooved edge. FIG. 26 shows a side cross section view of enclosure 25′c with ball bearings 28 trapped between it and rack strip member 25′e in the channels in the upper and lower outer walls of this enclosure and the channels in the grooved edges of rack strip member 25′e.

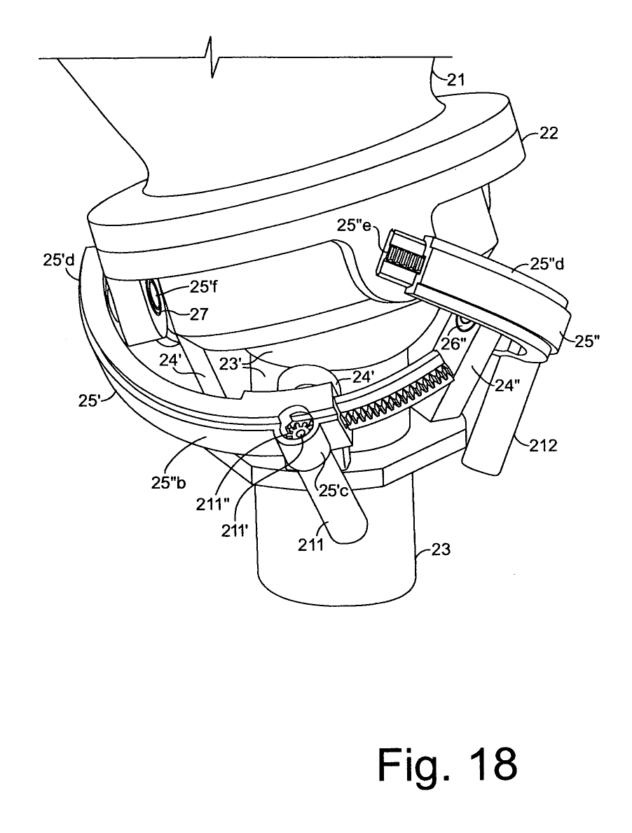

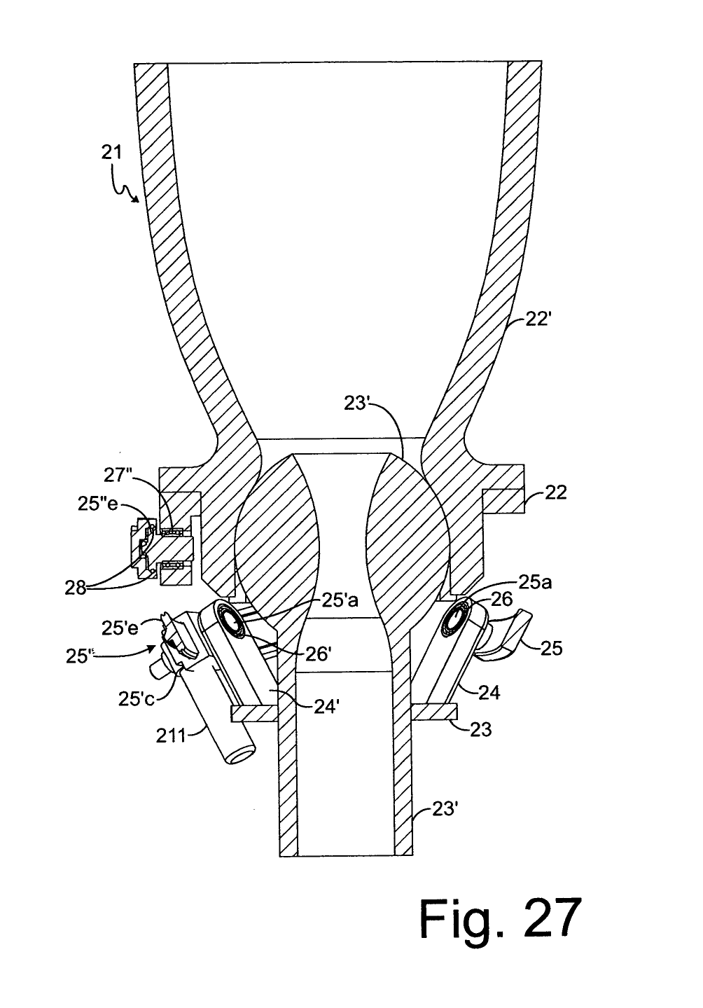

The rotatable connection between linking structure 25′ and output structure 22 is provided by pin 25′f extending into the circular opening in the inner race of a bearing, 27′, with its collar against that race. Bearing 27′ has its outer race fixed in a circular hole in the side of output structure 22 (with this structure having an outward protruding extension collar there to effectively deepen that hole) as seen to at least some extent in FIGS. 18 and 20. A more complete showing is provided in the side cross section view of manipulator 21 in FIG. 27 which corresponds to a section line, 27-27, indicated in the top view of FIG. 19 which is rotated from section line 23-23 of that figure leading to the view in FIG. 27 being rotated approximately 90° along the vertical from the view shown thereof in FIG. 23.

Similarly, compound linking structure 25″ further has a rack strip member, 25″e, variably positionable in the rotary force assertion space and interior track space of outer track member 25″b. Rack strip member 25″e has an outer major surface on one side thereof and an inner major surface on the opposite side thereof along the length of that member with each major surface extending between two grooved edges on opposite sides of these major surfaces that are grooved by each edge having a recessed channel therein along the length of that member. The outer major surface of rack strip member 25″e has gear teeth symmetrically positioned between the grooved edges thereof along the length of that member, and the inner major surface is flat between the grooved edges along the member length except for having affixed thereat a circular pin, 25″f, with a collar at its fixedly supported root, extending toward the interior of the structure and can be capable of so extending, in some relative positions, through the slot in outer track member 25″b.

Additional ones of ball bearings 28 are trapped in the channels of the grooved edges of rack strip member 25″e by the interior sides of enclosure 25″c and partially enclosed track structure 25″d of outer track member 25″b which also have channels therein across from those of the grooved edges to aid in trapping ball bearings 28. Ball bearings 28 are otherwise free to rotate in those channels to thereby enable rack strip member 25″e to be moved to various positions within outer track member 25″b with much reduced friction in doing so. The arrangement shown for linking structure 25′ in FIGS. 24, 25 and 26 is also followed for linking structure 25″.

The rotatable connection between linking structure 25″ and output structure 22 is provided by pin 25″f extending into the circular opening in the inner race of a bearing, 27″, with its collar against that race. Bearing 27″ has its outer race fixed in a circular hole in the side of output structure 22 as seen to at least some extent in FIGS. 16, 18 and 20. The axes of rotations of output structure 22 about circular pins 25b, 25′f and 25″f are indicated by dashed lines, 29, 29′ and 29″ in the figures where they are shown corresponding to those pins, these axes shown meeting at a common point. A dashed line output axis, 210, symmetrically positioned with respect to circular pins 25b, 25′f and 25″f and rotation axes 29, 29′ and 29″, as well as being positioned symmetrically with respect to workpiece 22′, is also shown in the figures corresponding to those pins and axes to thereby result in axis 210 extending from the common intersection point of rotation axes 29, 29′ and 29″.

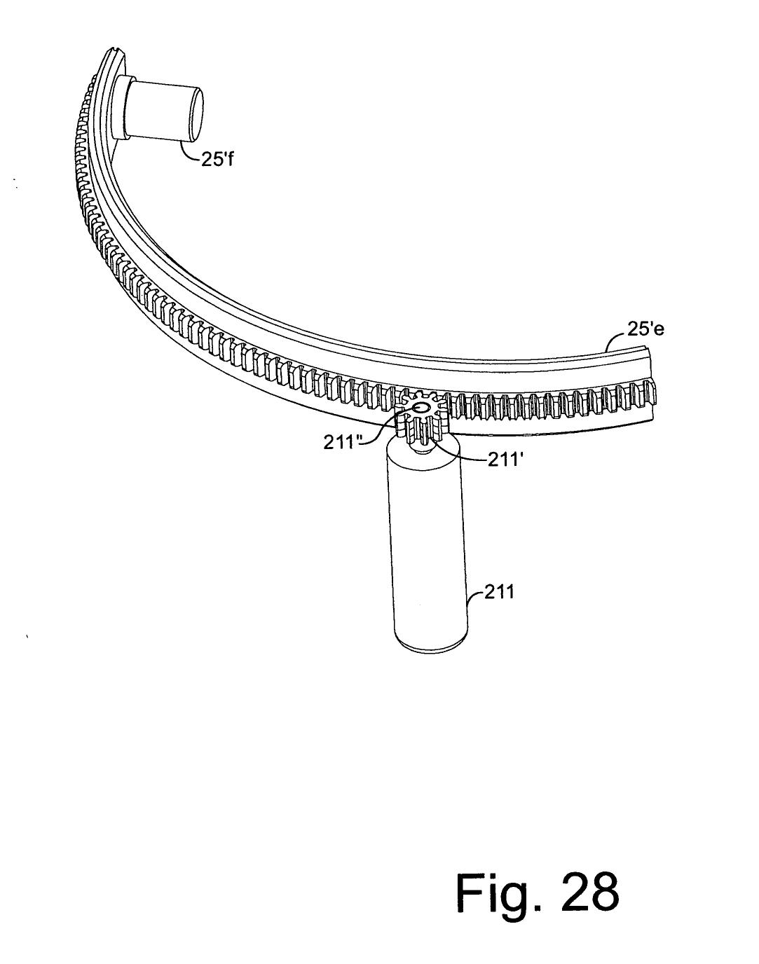

As seen in many of the figures, there is a pair of electric motors, 211 and 212, that can be used to cause the compound linking structures 25′ and 25″, respectively, to undergo a change their lengths along the length variation paths followed thereby under control of a rack strip member positioning control system (not shown) to thereby set the orientation of axis 210. Thus, motor 211 has an output shaft, 211′, extending therefrom to support and rotate a spur type pinion gear, 211″, that is engaged with the gear teeth at the outer major surface of rack strip member 25′e in the rotary force assertion space within enclosure 25′c of outer track member 25′b. Though, as indicated, this arrangement is seen in many of the figures, it is best seen in FIGS. 24, 25 and 26 and is further shown in the perspective view of FIG. 28. Selectively rotating pinion gear 211″ with motor 211 allows variably positioning rack strip member 25′e in the rotary force assertion space and interior track space of outer track member 25′b through the force applied on the gear teeth of rack strip member 25′e forcing that member to move with respect to outer track member 25′b so as to either increase or decrease the separation distance between circular pin 25T and circular pin 25′a depending on the direction of rotation selected for motor 211 to rotate pinion gear 211″. An increase in the separation distance results in linking structure 25′ pushing output structure 22 away from support standard 24′, and decreasing that distance results in linking structure 25′ pulling them toward one another, thereby, in either instance, changing the spatial orientation of output axis 210 through rotations of output structure 22 about some or all of axes 29, 29′ and 29″.

Similarly, motor 212 has an output shaft, 212′, extending therefrom to support and rotate a spur type pinion gear, 212″, that is engaged with the gear teeth at the outer major surface of rack strip member 25″e in the rotary force assertion space within enclosure 25″c of outer track member 25″b. As indicated, this arrangement for motor 212 changing the length of linking structure 25″ is seen in many of the figures and follows the same arrangement used for motor 211 changing the length of linking structure 25′. Thus, selectively rotating pinion gear 212″ with motor 212 allows variably positioning rack strip member 25″e in the rotary force assertion space and interior track space of outer track member 25″b through the force applied on the gear teeth of rack strip member 25″e forcing that member to move with respect to outer track member 25″b so as to either increase or decrease the separation distance between circular pin 25″f and circular pin 25″a depending on the direction of rotation selected for motor 212 to rotate pinion gear 212″. Here too, increasing the separation distance results in linking structure 25″ pushing output structure 22 away from support standard 24″, and decreasing that distance results in linking structure 25″ pulling them toward one another, thereby, in either instance, changing the spatial orientation of axis output 210 through rotations of output structure 22 about some or all of axes 29, 29′ and 29″.

These motions of the rack strip members with respect to the corresponding one of the outer track members more or less containing it can be coordinated through the selective operations of motors 211 and 212 to position output axis 210 as desired in a conical workspace. Fixed length linking structure 25 is correspondingly forced to move by the resulting movement of output structure 22 with respect to support standard 24. In doing so, linking structure 25 stabilizes the motion of output structure 22 by limiting the range of motions otherwise available to output structure 22 in being rotated by motors 211 and 212. If the user is willing to accept a reduced range of motion in orienting axis 210, one of motors 211 and 212 can be kept in a fixed position, or eliminated altogether by substituting a fixed length linking structure for the compound linking structure associated with that motor.

FIGS. 21 and 22 show two different positions of output axis 210 with, in FIG. 21, both of linking structures 25′ and 25″ being relatively extended to thereby provide relatively larger pins separation distances and forcing linking structure 25, as a result, to keep the location on output structure 22 to which it is rotatably connected relatively close to base 23 to thereby tilt that output structure relatively toward that connection location. In FIG. 22, in contrast, both of linking structures 25′ and 25″ are relatively short and so linking structure 25, as a result, forces the location on output structure 22 to which it is rotatably connected to move upward relatively farther from base 23 to thereby tilt that output structure more toward a location halfway between the rotatable connections of linking structures 25′ and 25″ thereto. Increasing the length of one of linking structures 25′ and 25″ while decreasing the length of the other will move output axis 210 to one side or the other of the plane that axis followed in responding to the joint lengthening and shortening of those linking structures described just above.

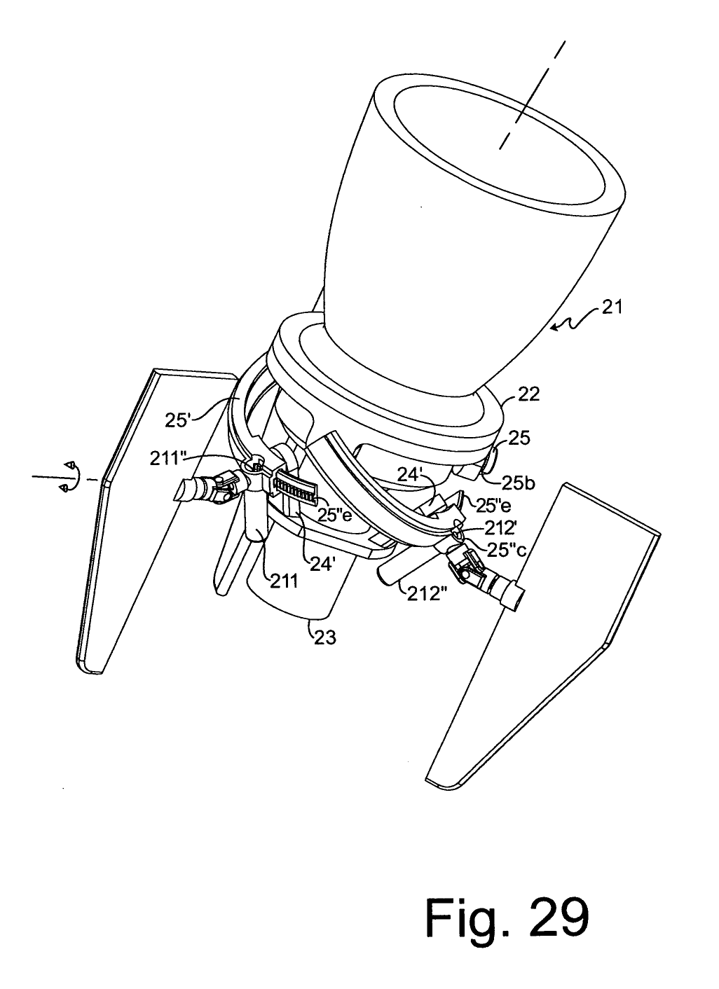

FIG. 29 shows a further embodiment with airfoils added externally to the missile through being added to each of the three linkages. Universal joints are used to connect the pivoting actuators to the airfoils. As the rocket nozzle direction is forced to change the airfoils move in a complimentary direction to augment the force provided by the thrust vectoring to thereby cause course shifts of the missile at greater turning rates.

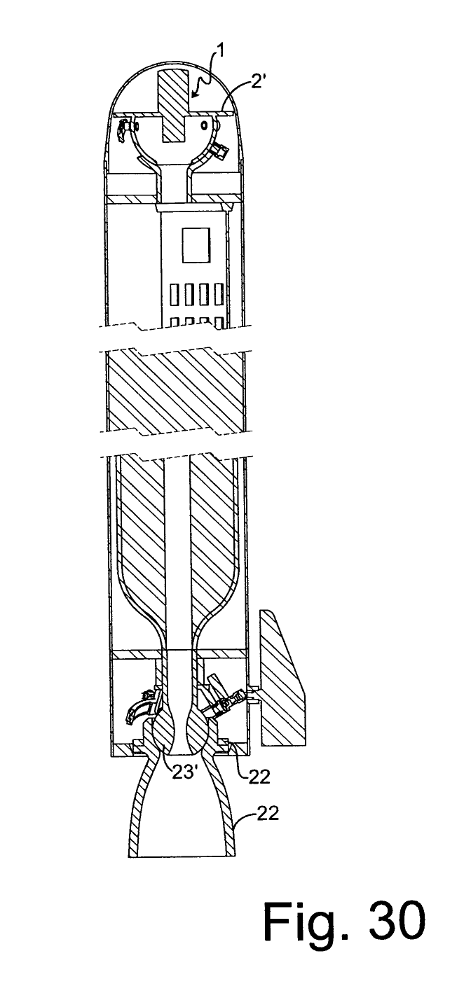

FIG. 30 shows the rocket which has a sensor manipulator located in the nose cone. Behind this is a space for electronics such as servo amplifiers, controller boards, CPU and other electronic and electrical components. Behind this component are the munitions or some explosive charge of the missile. In the rear of the missile is the rocket motor which attaches to the rocket nozzle actuator for thrust vector control.

In the nozzle actuation system disclosed herein backlash has been greatly reduced if not eliminated by manipulator 21. The system requires a relatively small housing volume for the manipulator to provide this enhanced performance because of the curvilinear linkages used, and used to provide both thrust vector control and augmenting airfoil control. This combined control system uses only the same number drive motors as in a more conventional three-axis airfoil manipulator. This also permits the elimination of a substantial amount of supporting electronics and electromechanical components with a corresponding weight reduction.

A further benefit is the reduction of fabrication costs resulting from the reduction in the number of components in the system. Several individual components which are employed perform dual functions, in effect, because they serve the same function with respect to both the airfoil control system and the thrust vector control system. In addition to this reduction in cost, the reduction in the number of required components provides for improved system operational reliability in that there are fewer parts to fail.

Although the present invention has been described with reference to preferred embodiments, workers skilled in the art will recognize that changes may be made in form and detail without departing from the spirit and scope of the invention.

1. A controlled relative motion system permitting a controlled motion member, joined to a base member, to selectively move with respect to said base member, said system comprising:
a base support,
an output structure,
a plurality of securing links each rotatably connected at one end thereof to said base support and rotatably connected at an opposite end thereof to said output structure, including a fixed length securing link that is rotatably connected at one end thereof to said base support and rotatably connected at an opposite end thereof to said output structure, and further including a variable length securing link that is rotatably connected at one end thereof to said base support and rotatably connected at an opposite end thereof to said output structure and that also has a rotatable capstan therewith about which a cable can be selectively wrapped or unwrapped through rotating said capstan with said cable having a capstan end thereof affixed to said capstan and an opposite end thereof affixed to said variable length securing link so as to have rotation of said capstan vary a separation distance between said ends of said variable length securing link, and
a force imparting member coupled to said capstan and capable of directing said capstan to vary said separation distance between said variable length securing link ends.

2. The apparatus of claim 1 wherein each of said plurality of securing links extends along a corresponding circular arc axis.

3. The apparatus of claim 1 wherein said variable length securing link has an inner member that is at least partially surrounded by an outer member and that is moveable with respect thereto, said outer member having a rotation connection end that is also one of said variable length securing link ends and said inner member having a rotation connection end that is also that remaining one of said variable length securing link ends.

4. The apparatus of claim 1 wherein said capstan is a double capstan with said cable being a first cable that wraps in one angular direction thereabout and wherein there is a second cable that can be selectively wrapped in an opposite angular direction thereabout, or unwrapped, through rotating said double capstan with said second cable having a capstan end thereof affixed to said capstan and an opposite end thereof affixed to said variable length securing link so as to have rotation of said capstan vary a separation distance between said ends of said variable length securing link.

5. The apparatus of claim 1 wherein said plurality of securing links consists of three securing links each rotatably connected at one end thereof to said base support with substantially equal angular spacing therebetween, and also each rotatably connected at an opposite end thereof to said output structure with substantially equal angular spacing therebetween.

6. The apparatus of claim 5 wherein said force imparting member is a first force imparting member, said plurality of securing links includes said fixed length securing link, said variable length securing link as a first variable length securing link, and a second variable length securing link that is rotatably connected at one end thereof to said base support and rotatably connected at an opposite end thereof to said output structure and that also has a rotatable second capstan therewith about which a second cable can be selectively wrapped or unwrapped through rotating said second capstan with said second cable having a capstan end thereof affixed to said second capstan and an opposite end thereof affixed to said second variable length securing link so as to have rotation of said second capstan vary a separation distance between said ends of said second variable length securing link, a second force imparting member coupled to said second variable length securing link second capstan capable of directing said second capstan to vary said separation distance between said second variable length securing link ends.

7. The apparatus of claim 6 wherein each of said plurality of securing links extends along a corresponding circular arc axis.

8. The apparatus of claim 6 wherein each said first and second variable length securing links has an inner member that is at least partially surrounded by an outer member and that is moveable with respect thereto, said outer member of a corresponding said variable length securing link having a rotation connection end that is also one said end of said corresponding said variable length securing link and said inner member of that corresponding said variable length securing link having a rotation connection end that is also that remaining said end of that said corresponding variable length securing link.

9. The apparatus of claim 8 wherein each of said first and second capstans is a double capstan with said first cable being a cable that wraps in one angular direction about said first capstan and wherein there is a third cable that can be selectively wrapped in an opposite angular direction thereabout, or unwrapped, through rotating said first capstan with said third cable having a capstan end thereof affixed to said first capstan and an opposite end thereof affixed to said first variable length securing link so as to have rotation of said first capstan vary a separation distance between said ends of said first variable length securing link, and with said second cable being a cable that wraps in one angular direction about said second capstan and wherein there is a fourth cable that can be selectively wrapped in an opposite angular direction thereabout, or unwrapped, through rotating said second capstan with said fourth cable having a capstan end thereof affixed to said second capstan and an opposite end thereof affixed to said second variable length securing link so as to have rotation of said second capstan vary a separation distance between said ends of said second variable length securing link.

10. The apparatus of claim 1 wherein said base support has a passageway therethrough opening to said output structure.

11. A controlled relative motion system in a vehicle capable of motion through a fluid medium and permitting a controlled motion member, joined to a base member, to selectively move with respect to said base member, said system comprising:
a base support having therein at least in part a jet propulsion engine exhaust fixed portion nozzle,
an output structure having therein at least in part a jet propulsion engine exhaust selectively moveable portion nozzle in sliding contact about said jet propulsion engine exhaust fixed portion nozzle,
a plurality of securing links each rotatably connected at one end thereof to said base support and rotatably connected at an opposite end thereof to said output structure, including a fixed length securing link that is rotatably connected at one end thereof to said base support and rotatably connected at an opposite end thereof to said output structure, and further including a variable length securing link that is rotatably connected at one end thereof to said base support and rotatably connected at an opposite end thereof to said output structure and that also has a force distributor therewith that can be directed to vary a separation distance between said ends thereof, and
a force imparting member coupled to said variable length securing link force distributor capable of directing said force distributor to vary said separation distance between said variable length securing link ends.

12. The apparatus of claim 11 wherein each of said plurality of securing links extends along a corresponding circular arc axis.

13. The apparatus of claim 11 wherein said variable length securing link has an inner member that is at least partially surrounded by an outer member and that is moveable with respect thereto, said outer member having a rotation connection end that is also one of said variable length securing link ends and said inner member having a rotation connection end that is also that remaining one of said variable length securing link ends.

14. The apparatus of claim 11 wherein said jet propulsion engine exhaust fixed portion nozzle ends as a ducted partially hemispherical outer surface support and said jet propulsion engine exhaust selectively moveable portion nozzle has a partially hemispherically hollowed supported structure with a passageway therethrough.

15. The apparatus of claim 14 wherein said ducted partially hemispherical outer surface support of said jet propulsion engine exhaust fixed portion nozzle ends has a duct therein that is narrowed in a location with respect to other locations therein.

16. The apparatus of claim 14 wherein said passageway in said jet propulsion engine exhaust selectively moveable portion nozzle flares outward past said partially hemispherically hollowed supported structure.

17. The apparatus of claim 11 wherein said plurality of securing links consists of three securing links each rotatably connected at one end thereof to said base support with substantially equal angular spacing therebetween, and also each rotatably connected at an opposite end thereof to said output structure with substantially equal angular spacing therebetween.

18. The apparatus of claim 17 wherein said force imparting member is a first force imparting member and said plurality of securing links includes said fixed length securing link, said variable length securing link as a first variable length securing link, and a second variable length securing link that is rotatably connected at one end thereof to said base support and rotatably connected at an opposite end thereof to said output structure and that has a force distributor therewith that can be directed to vary a separation distance between said ends thereof, a second force imparting member coupled to said second variable length securing link force distributor capable of directing said force distributor to vary said separation distance between said second variable length securing link ends.

19. The apparatus of claim 18 wherein each of said plurality of securing links extends along a corresponding circular arc axis.

20. The apparatus of claim 18 wherein each said first and second variable length securing links has an inner member that is at least partially surrounded by an outer member and that is moveable with respect thereto, said outer member of a corresponding said variable length securing link having a rotation connection end that is also one said end of said corresponding said variable length securing link and said inner member of that corresponding said variable length securing link having a rotation connection end that is also that remaining said end of that said corresponding variable length securing link.

21. The apparatus of claim 11 further comprising a controlled signal processing relative motion system in said vehicle and permitting a controlled motion electromagnetic signal receiving member, joined to a base member, to selectively move with respect to said base member in which there is a signal processing base support through which signal carrying conductors can be positioned, and also having an output structure including therein at least in part an electromagnetic signal receiving member for receiving electromagnetic signals through said fluid medium to which said signal carrying conductors are connected, there further being a plurality of securing links each rotatably connected at one end thereof to said base support and rotatably connected at an opposite end thereof to said output structure, including a fixed length securing link that is rotatably connected at one end thereof to said base support and rotatably connected at an opposite end thereof to said output structure, and further including a variable length securing link that is rotatably connected at one end thereof to said base support and rotatably connected at an opposite end thereof to said output structure and that also has a force distributor therewith that can be directed to vary a separation distance between said ends thereof, and a force imparting member coupled to said variable length securing link force distributor capable of directing said force distributor to vary said separation distance between said variable length securing link ends.

22. The apparatus of claim 11 wherein said jet propulsion engine exhaust fixed portion nozzle is a rocket motor exhaust fixed portion nozzle and said jet propulsion engine exhaust selectively moveable portion nozzle is a rocket motor exhaust selectively moveable portion nozzle.
